(19) United States
(12) Patent Application Publication
(10) Pub. No.: US 2011/0095935 A1
(43) Pub. Date: Apr. 28, 2011

(54) ELECTROMAGNETICALLY-COUNTERED SYSTEMS AND METHODS BY MAXWELL EQUATIONS

(76) Inventor: Youngtack SHIM, Seoul (KR)

(21) Appl. No.: 12/985,042

(22) Filed: Jan. 5, 2011

Related U.S. Application Data
(63) Continuation-in-part of application No. 11/510,667, filed on Aug. 28, 2006, now Pat. No. 7,876,917.

(51) Int. Cl. G01S 7/38; H02J 17/00; H04B 15/00

(52) U.S. Cl. 342/14; 307/149; 455/63.1

(57) ABSTRACT

Various electromagnetically-countered systems (EMC systems) are provided to form a target space where an intensity of harmful electromagnetic waves is reduced by a preset extent or below a preset limit. The EMC system includes at least one counter unit which emits counter electromagnetic waves capable of countering the harmful waves by canceling at least a portion of the harmful waves in the target space or by suppressing the harmful waves from propagating into the target space. As the countering is performed by the canceling, the counter waves tend to counter the harmful waves while impeding the purpose of the system in the target space. However, as the countering is done by the suppressing, the counter waves tend to oppose the harmful waves while facilitating the purpose of the system at least outside the target space.

### CROSS-REFERENCES TO RELATED APPLICATIONS

This application is a continuation-in-part patent application of U.S. application Ser. No. 11/510,667 filed on Aug. 28, 2006, the entire contents of which are hereby incorporated by reference for which priority is claimed under 35 U.S.C. §120.

### TECHNICAL FIELD

The present disclosure relates to electric and electronic systems which are capable of forming target spaces in which harmful electromagnetic waves irradiated by wave sources are countered by counter electromagnetic waves emitted by counter members of the system and, accordingly, in which intensity of the harmful waves are minimized, and in which users of such systems or other people are spared from irradiation of the harmful waves.

### BACKGROUND

It is now well established in the scientific community that electromagnetic waves with varying frequencies irradiated by various electric and electronic devices may be hazardous to human health. In some cases, such harmful electromagnetic waves in mega- and giga-hertz range may be the main culprit, while those with very-low or extremely-low frequency may be main health concerns in other cases.

Intensity of such harmful electromagnetic waves typically decreases inversely proportional to a square of a distance from a wave source of such waves to a target space. Accordingly, potential adverse effects from such harmful waves may be minimized by maintaining a safe distance from the wave source. In many circumstances, however, keeping the safe distance may happen to defeat the very purpose of such electric and electronic devices. In one example, various resistive and radiative heating devices should be used in proximity to their users, for an amount of heat delivered from such devices to the users should be maximized. Keeping a distance from various heating devices such as a heater, a heating mattress, a heating blanket, a heating pad, a hair drier, and so on, only defeats the purpose of the devices. In another example, those devices including various actuators should be used proximate to their users. Keeping the distance from the actuators such as an electric motor included in an electric razor, electric toothbrush or other portable devices only defeats their purposes. In another example, various audio devices, visual devices, audiovisual devices, and devices including the audio and/or visual devices should be used proximate to their users, for human ears and eyes can properly function only in a certain distance. Therefore, disposing the audio devices such as speakers included in a earphones, a headphone, a head-mount device, a cellular phone, a smart phone, and the like, and staying away from various display devices such as a television, a monitor, and the like, each including at least one light transmitting element, light reflecting element, light emitting element, and the like, either big or small, only defeats the original purposes of such devices. In another example, various portable devices must be kept close to their users, for the devices which can be kept away from the users are not ‘portable’ by definition. In particular, various portable communication devices must be kept close to their users, for those devices include signal transmitters or antennas which transmit electromagnetic waves carrying signals. Because the portable communication devices should be made compact, their users have to use the devices in close proximity, while letting the transmitters to irradiate the harmful electromagnetic waves to vital organs such as their brains. Therefore, keeping a distance from such devices again defeats the purpose of such devices.

Different situations arise in which one is exposed to the harmful waves, not necessarily while wielding any electric or electronic device in his own will but rather involuntarily. In one example, one is exposed to such harmful electromagnetic waves irradiated from electric power lines. In particular, the power lines carrying high-ampere electric current are known to irradiate the harmful waves of greater magnitudes and to cause various health hazards. In another example, one is exposed to such harmful electromagnetic waves constituting wireless networks which rampantly penetrate into each corner of our society. Keeping the distance from such wireless networks, whether local, regional or global, only means an evasion from the civilization. In another example, one is exposed the harmful waves which carry energy to various electric and electronic devices. In particular, such waves tend to carry more energy than those from the power lines or for the networks, for the primary purpose of these waves is to deliver energy wirelessly.

Other adverse health effects of such harmful electromagnetic waves have been described in U.S. patent applications which carry Ser. Nos. 11/510,667, 12/318,538, 12/318,539, 12/318,671, 12/318,543, 12/318,544, 12/318,546, 12/318,540, and the like.

Therefore, there is an urgent need for a generic electric or electronic system which can form a target space in which the harmful electromagnetic waves irradiated by wave sources of the system are countered by counter electromagnetic waves emitted by counter members of the system and then attenuated to a preset intensity.

### SUMMARY

The present invention generally relates to electromagnetically-countered electric or electronic systems which will be referred to as the “EMC electric or electronic systems” or simply as the “EMC systems” hereinafter. More particularly, the present invention relates to various EMC systems each of which incorporates therein at least one counter unit and defines a target space in which an intensity of electromagnetic waves is to be maintained below a preset limit.

In one general aspect, the present invention relates to a system including at least one wave source which includes at least one base unit which is configured to include only portions of the wave source which are responsible for irradiating harmful electromagnetic waves and/or affecting paths of propagation of the harmful waves therealong or therethrough. The base unit has first characteristics such as, e.g., its first composition of matter, its first configuration, its first path of first electric current defined therein, and/or first dynamic property of the first electric current flowing in the first path (to be referred to as “the First Characteristics” hereinafter). The wave source irradiates the harmful waves to attain a preset purpose of the system. Such a system comprises at least one counter unit which is configured to have second characteristics such as, e.g., its second composition of matter, its second configuration, its second path of second electric current defined therein, second dynamic property of the second electric current flowing in the second path, and its disposition relative to the base unit (to be referred to as “the Second Characteristics” hereinafter), and then to emit counter electromagnetic waves capable of countering at least a portion of the harmful waves by canceling at least a portion of the harmful waves inside the target space and/or suppressing at least a portion of the harmful waves from propagating into the target space. Accordingly, the counter waves can decrease an intensity of the harmful waves in the target space by a preset extent. At least one of the Second Characteristics is determined based on at least one solution of at least one of Gauss law, Gauss law for magnetism, Faraday's law of induction, Ampere's circuital law, and Lorentz force law in such a way that such counter waves are capable of performing the countering by the preset extent in the target space. The above five equations or laws are to be referred to as “the Equations” hereinafter.

Implementation of the above aspect may include one or more of the following embodiments.

In one embodiment, the Equations may be provided in a differential form in terms of free charge and current, a differential form in terms of total charge and current, an integral form in terms of free charge and current, or an integral form in terms of total charge and current. The solution may be an analytical or numerical solution of at least one of the Equations, an approximation (or simplification) of at least one of the solutions, an analytical or numerical solution of an approximation (or simplification) of at least one of the Equations, or a combination of any of the above.

In another embodiment, the harmful waves may define frequencies which are mainly less than about 1 kHz, from about 1 kHz to about 1 MHz, from about 1 MHz to about 1 GHz, higher than about 1 GHz, and so on. The solution is used to determine at least one of the Second Characteristics in such a way that the counter waves define frequencies at least partially matching those of the harmful waves and performing the countering by the preset extent. In another embodiment, the counter waves may perform the countering over an entire frequency range of the harmful waves, in only a single portion of the range, or at least two different portions of the range.

In another embodiment, the solution may be used so as to determine at least one of the Second Characteristics in such a way that the counter unit performs the countering which may be completely, at least substantially or at most partially impeding the purpose, which may be neutral to the purpose, which may be at most partially, at least substantially or completely facilitating the purpose, and the like. In another embodiment, at least a portion of the counter unit may be incorporated into the wave source in a contiguous configuration so that the base unit and counter unit are either physically or electrically contiguous. At least a portion of the counter unit may be disposed separately from the wave source in a separate configuration instead such that the counter unit are physically or electrically separate from the base unit.

In another embodiment, the solution may be used so as to determine at least one of the Second Characteristics in such a way that the counter unit may be disposed in various dispositions. In the first example, the counter unit may be disposed between the space and base unit, where amplitudes of the counter waves are less than those of the harmful waves. In the second example, the counter unit is disposed on an opposite side of the target space with respect to the base unit, where the counter waves have amplitudes enough to perform the countering by the extent. In the third example, such a counter unit is disposed at a first distance from a center of the target space, where the first distance is neither substantially greater nor substantially less than a second distance between the base unit and the center of the target space and where the counter waves have amplitudes enough to perform the countering by such a extent. In the fourth example, the counter unit is disposed at a third distance from the center, where the third distance is substantially greater or less than the second distance and where the counter waves have amplitudes enough to perform the countering by the extent.

In another embodiment, the solution may be used so as to determine at least one of the Second Characteristics in such a way that the counter unit is configured to define the target space in various zones. The target space may be a two-dimensional first zone defined in a preset relation with respect to the counter unit. The target space may be a three-dimensional second zone also defined in a preset relation to the counter unit. The target space may be a third zone formed about at least a portion of the counter unit. The target space may be a fourth zone defined along at least a portion of such a counter unit. The target space may be a fifth zone defined about at least one side of the counter unit or a sixth zone defined lateral to or side by side at least a portion of the counter unit. The target space may be a seventh zone defined angularly about at least a portion of the counter unit. The target space may be an eighth zone defined on or over at least a portion of the counter unit. The target space may also be a ninth zone defined in an elevation similar to at least a portion of the counter unit. The target space may be a tenth zone defined below or under at least a portion of the counter unit.

In another embodiment, the solution may be used so as to determine at least one of the Second Characteristics in such a way that the target space is configured to define an open space or a closed space. The wave source serves the purpose only about a preset angle thereabout with respect to the open target space, while the wave source is configured to serve the purpose outside the closed target space.

In another embodiment, the base unit defines various shapes such as, e.g., a curvilinear wire, a curvilinear coil or spiral, a ring, a curvilinear mesh, a curvilinear sheet or strip, a curvilinear cylinder, rod or tube, a sphere, a bead, a solenoid, a toroid, a truncation of any of the above, a fraction of any of the above, and a combination of any of the above. The solution may be used to determine at least one of the Second Characteristics in such a way that the counter unit has at least one of the shapes to emit the counter waves capable of performing the countering by the extent. In another embodiment, the base unit is made of or includes an electrically conductive material, an electrically semiconductive material or an electrically insulative material. The solution may be used to determine at least one of the Second Characteristics in such a way that the counter unit is configured to include at least one of the above materials so as to emit the counter waves capable of performing the countering by the extent.

In another embodiment, the Second Characteristics may also include a direction of the second electric current, a phase angle of the second electric current, a direction of propagation of the counter waves, and the like. The solution may then be used to determine at least one of the angle, propagation direction, and current direction, depending upon whether the counter waves perform the countering mainly by the canceling or suppressing.

In another embodiment, the solution may be used so as to determine at least one of the Second Characteristics in such a way that a second vector representing a net flux of the counter waves may be configured to at least partially cancel a first vector representing a net flux of the harmful waves in the target space for the countering by the preset extent. In another embodiment, the solution may be used to determine at least one of the Second Characteristics in such a way that the counter waves mainly cancel at least a portion of the harmful waves in the target space and, therefore, decrease the intensity of the harmful waves by the extent therein. In another embodiment, such a system may be a sound generating device, an electric heating device, an electricity generating device, a device capable of generating an electromotive force, an electric light emitting unit, and the like.

In another embodiment, the solution may be used so as to determine at least one of the Second Characteristics in such a way that a second vector representing a net flux of the counter waves may be configured to at least partially oppose a first vector representing a net flux of the harmful waves in the target space. In another embodiment, the solution may also be used to determine at least one of the Second Characteristics in such a way that the counter waves may primarily suppress at least a portion of the harmful waves from propagating into the target space and decrease the intensity of the harmful waves by the extent therein. In another embodiment, the system is a personal communication device, an areal communication device or a power transmission device. The solution may be used to determine at least one of the Second Characteristics in such a way that the target space encloses at least a portion of a preset region, and the wave source substantially serves the purpose outside the target space. In another embodiment, the system is a sound generating device, an electric heating device, an electricity generating device, a device generating an electromotive force or an electric light emitting unit.

In another embodiment, the solution may further be used to change at least one of the Second Characteristics in response to at least one change in at least one of the First Characteristics, thereby performing the countering by the extent despite the change. In another embodiment, at least a portion of the counter unit may be in a stationary arrangement or in a mobile arrangement with respect to the base unit. The solution is used to modify at least one of the Second Characteristics in the stationary arrangement or, alternatively, to move at least a portion of the counter unit in the mobile arrangement. Therefore, both arrangements ensure the counter waves to perform the countering by the extent. In another embodiment, the counter unit may incorporate therein at least one material of which magnetic permeability is different from that of the base unit or that of the target space. The solution may then be used to determine a composition of matter of the material, its shape, its size, and/or its disposition with respect to the counter unit, base unit, and/or target space so as to manipulate propagation path of the harmful and/or counter waves for the countering.

In another general aspect, the present invention relates to a portable communication system with at least one wave source including at least one base unit which defines the First Characteristics and includes at least one transmitting module which irradiates harmful electromagnetic waves which carry therealong information for a purpose of wireless communication. The system comprises at least one counter unit which defines the Second Characteristics and emits counter electromagnetic waves which are capable of countering at least a portion of the harmful waves through canceling at least a portion of the harmful waves in a target space or suppressing at least a portion of the harmful waves from propagating to the target space, thereby decreasing an intensity of the harmful waves inside the target space by a preset extent. At least one of the Second Characteristics of the counter unit may be determined based upon at least one solution of the Equations in such a way that the counter waves form the target space which encloses a substantial portion of a body of a user of the system, about a half of the body of the user, a head thereof or a brain thereof and in which the countering decreases the intensity of the harmful waves by the preset extent.

Implementation of the above aspect may include one or more of the following embodiments.

In one embodiment, the system further comprises a front side and a back side, where the front side is positioned toward an ear of the user during such communication. The solution may be used to determine at least one of the Second Characteristics in such a way that the counter waves form the target space which spans from at least a portion of the front side and widens in a forward direction toward the user, thereby enclosing therein the portion of the body, the half of the body, the head or the brain. In another embodiment, the target space defines a shape of an enclosed conduit extending from the front side to the user or an open channel traversing from the front side toward the user. In another embodiment, the solution is used to determine at least one of the Second Characteristics in such a way that the counter waves may define the target space not in an opposite direction of the forward direction, thereby minimizing impeding the communication purpose by the harmful waves.

In another general aspect, the present invention also relates to an areal communication system with at least one wave source including at least one base unit which defines the First Characteristics, which includes at least one transmitting module capable of irradiating harmful electromagnetic waves carrying therealong information for a purpose of wireless communication, and which is incorporated on a tower, a pole or a mast. The system comprises at least one counter unit which is configured to define the Second Characteristics and to emit counter electromagnetic waves which are capable of countering at least a portion of the harmful waves through canceling at least a portion of the harmful waves inside a target space or suppressing at least a portion of the harmful waves from propagating to the target space, thereby decreasing an intensity of the harmful waves inside the target space by a preset extent. At least one of the Second Characteristics is determined based on at least one solution of at least one of the Equations in such a way that the counter waves define the target space which may enclose a geographic area, at least one country, at least one city, at least one district, at least one city block, at least one building or at least one house and in which the countering decreases the intensity of the harmful waves by the preset extent.

Implementation of the above aspect may include one or more of the following embodiments.

In one embodiment, each of the tower, pole, and mast has a top and a bottom and the counter unit is disposed below or inside of the base unit. The solution is then used to determine at least one of the Second Characteristics of the counter unit in such a way that the counter waves define the target space which has a shape of a sphere, a cone, a ring, a portion of any of the above, a truncation of any of the above, and a combination of any of the above, thereby enclosing therein the area, country, city, district, block, building or house. In another embodiment, the system also comprises a third unit which emits third electromagnetic waves and which is disposed below or inside the counter unit. The third waves are then configured to counter the counter waves by canceling at least a portion of the counter waves inside the target space or suppressing at least a portion of the counter waves from propagating through the target space, thereby forming the target space defining the intensity which is relatively uniform throughout the target space than the intensity obtained without the third unit.

In another general aspect, the present invention also relates to a power transmission system with at least one wave source including at least one base unit which has the First Characteristics and includes at least one transmitting module which irradiates harmful electromagnetic waves which carry therealong electromagnetic energy for a purpose of wirelessly delivering electromagnetic power. The system comprises at least one counter unit which is configured to define the Second Characteristics and to emit counter electromagnetic waves which are capable of countering at least a portion of the harmful waves through canceling at least a portion of the harmful waves inside a target space and/or suppressing at least a portion of the harmful waves from propagating into the target space, thereby decreasing an intensity of the harmful waves in the target space by a preset extent. To this end, at least one of the Second Characteristics is determined based on at least one solution of at least one of the Equations in such a way that the counter waves form the target space which encloses therein at least one building, at least one house or at least one room and in which the countering decreases the intensity of the harmful waves by the preset extent.

Implementation of the above aspect may include one or more of the following embodiments.

In one embodiment, the solution is used to determine at least one of the Second Characteristics of the counter unit in such a way that the counter waves form the target space in multiple portions of the building, house or room which warrant frequent contact with persons, while the counter waves perform the countering at most minimally in the rest of the building, house or room which warrants the least contact with persons to allow the power transmission. In another embodiment, the solution is used to determine at least one of the Second Characteristics in such a way that the counter waves may perform the countering at most minimally in a ceiling, a wall, a space between the walls, a crawl space or a dead space of the building, house or room.

In another general aspect, the present invention relates to a system including at least one base unit which defines the First Characteristics. The base unit may serve a preset purpose by irradiating the harmful waves which propagate around at least a portion of the base unit and define therearound an active space in which an intensity of the harmful waves exceeds a preset limit. The system also defines in the active space at least one target space in which the intensity of the harmful waves is to be below the limit. The system comprises at least one counter unit which is configured to define the Second Characteristics, and then to emit counter electromagnetic waves. At least one of the Second Characteristics is determined based upon at least one solution of the Equations in such a way that the counter waves are capable of countering at least a portion of the harmful waves through canceling at least a portion of the harmful waves in the target space and/or suppressing at least a portion of the harmful waves from propagating into the target space, thereby defining in the active space the target space which has a preset shape with a preset cross-section, a preset size, and a preset disposition and in which the intensity of the harmful waves is to be maintained below the limit.

Implementation of the above aspect may include one or more of the following embodiments.

In one embodiment, the solution is used to determine at least one of the Second Characteristics in such a way that the counter waves may perform the countering which may be completely, at least substantially or at most partially impeding such harmful waves from serving the purpose, which may be mainly neutral to the harmful waves in serving such a purpose, or which may be at most partially, at least substantially or completely facilitating the harmful waves in serving the purpose.

In another embodiment, the solution may be used so as to determine at least one of the Second Characteristics in such a way that the intensity of the harmful waves in the target space is less than the limit but greater than a minimum threshold enough to serve the purpose such that the base unit at least minimally serve the purpose in at least a substantial portion of the target space while the counter unit performs the countering. In another embodiment, the solution is used to determine at least one of the Second Characteristics in such a way that the intensity of the harmful waves in the target space is less than the limit but defines various distributions. In one distribution, the intensity is greatest near a boundary or border of the target space. In another distribution, the intensity is at least partly uniform in a substantial portion of the target space or is lowest near the counter unit. In another distribution, the intensity is lowest between at least two of multiple counter units.

In another embodiment, the solution may be used so as to determine at least one of the Second Characteristics of the counter unit in such a way that the target space forms a cross-section which defines various two-dimensional shapes such as, e.g., a triangle, a square, a diamond, a rectangle, a trapezoid, a polygon having at least five sides, a polygon having at least one curved side, a circle, an annulus, a crescent, an ellipse, an oval, a shape with at least one parabolic side, a shape including at least one hyperbolic side, a shape with an arcuate side, a lemniscate, an astroid, a lune, a deltoid, a fraction of any of the above, a truncation of any of the above, any of the above shapes with at least one rounded corner, and a combination of any of the above. In this embodiment, the solution is used to determine at least one of the Second Characteristics of the counter unit in such a way that the target space forms a volume which has various three-dimensional shapes such as a sphere, a hemisphere, a cone, a cube, a polyhedron, an ellipsoid, any three-dimensional volume which may be obtained by translating, rotating, and/or revolving at least one of the above two-dimensional shapes, a truncation of any of the above, a fraction of any of the above, and a combination of any of the above.

In another embodiment, the solution may be used so as to determine at least one of the Second Characteristics in such a way that the target space may be disposed in various dispositions. In a first disposition, the target space is entirely enclosed within the active space. In a second disposition, the target space is partially enclosed by the active space and open through a single portion a border or a boundary of the active space to an exterior of the active space. In a third disposition, the target space traverses through the active space while forming a conduit therethrough. In a fourth disposition, the target space traverses through the active space while dividing such into at least two separate smaller active spaces.

In another embodiment, at least a portion of the counter unit may be incorporated into the wave source in a contiguous configuration such that the base and counter units are physically or electrically contiguous. Alternatively, at least a portion of the counter unit is disposed separately from the wave source in a separate configuration such that the counter unit is physically or electrically separate from the base unit. In another embodiment, the base unit is made of or includes an electrically conductive material, an electrically semiconductive material, and/or an electrically insulative material. The solution is then used to determine at least one of the Second Characteristics in such a way that the counter unit is configured to incorporate at least one of the materials and to form the target space which has at least one of the above shape, cross-section, size, and disposition and in which the intensity of the harmful waves is maintained below the limit.

In another embodiment, the solution may be used so as to determine at least one of the Second Characteristics of the counter unit in such a way that the target space may define various sizes. The target space may have a first size which is about as large as the active space. The target space may have a second size which is smaller than the active space. The target space may have a third size which corresponds to a size of at least one corner of the active space. The target space may have a fourth size which corresponds to a size of at least one strip formed across or along at least a portion of the active space. The target space may have a fifth size which is large enough to enclose therein a preset local geographic area. The target space may have a sixth size large enough to enclose at least two people therein. The target space may have a seventh size which is smaller than the sixth size but large enough to enclose therein a single user of the system. The target space may define an eighth size which is large enough to enclose therein at least a substantial portion of a body of the user. The target space may define a ninth size which is large enough to enclose therein about one half of the body of the user. The target space may have a tenth size which is large enough to enclose therein a head of the user. The target space may have an eleventh size large enough to enclose therein a brain of the user.

In another embodiment, such Second Characteristics further include a direction of the second electric current, a phase angle of the second electric current, and a direction of propagation of such counter waves. The solution is used to determine at least one of the second angle, current direction, and propagation direction in such a way to determine whether the counter waves are performing the countering mainly by either of the canceling and suppressing.

In another embodiment, the solution may be used so as to determine at least one of the Second Characteristics in such a way that the counter waves mainly cancel at least a portion of such harmful waves in the target space and form the target space which has one of the above sizes in which the intensity of the harmful waves is maintained below the limit. In this embodiment, the system may be a sound generating device, an electric heating device, an electricity generating device, a device capable of generating an electromotive force or an electric light emitting unit. The solution is used to determine at least one of the Second Characteristics to define the target space which defines the first, second, third, fourth, sixth, seventh, eighth, ninth, tenth or eleventh size.

In another embodiment, the solution may be used so as to determine at least one of the Second Characteristics in such a way that the counter waves may primarily suppress at least a portion of the harmful waves from propagating into the target space and, therefore, define the target space which has one of the above sizes in which the intensity of the harmful waves is maintained below the limit. In such an embodiment, the system may be a personal communication device, an areal communication device or a power transmission device. The solution is used to determine at least one of the Second Characteristics and to define the target space which has the second, third, fourth, sixth, seventh, eighth, ninth, tenth or eleventh size for the personal communication device. The solution is also used to determine at least one of the Second Characteristics and to define the target space which has the first, second, third, fourth, fifth or sixth size for the areal communication device. The solution is also used to determine at least one of the Second Characteristics and to form the target space which has the first, second, third, fourth, fifth, sixth, seventh, eighth or ninth size for the power transmission device. In this embodiment, the system may be a sound generating device, an electric heating device, an electricity generating device, a device generating an electromotive force or an electric light emitting unit. The solution is then used to determine at least one of the Second Characteristics and to form the target space which has the first, second, third, fourth, sixth, seventh, eighth, ninth, tenth or eleventh size.

In another embodiment, the solution may rather be used in changing at least one of the Second Characteristics in response to at least one change in at least one of the First Characteristics, thereby defining the target space which have the above shape, cross-section, size, and/or disposition and in which the intensity of the harmful waves is maintained below the limit. In another embodiment, at least a portion of the counter unit is in a mobile arrangement or in a stationary arrangement. The solution is used to modify at least one of the Second Characteristics in the stationary arrangement or to move at least a portion of the counter unit in the mobile arrangement in such a way that the counter waves are ensured to define the target space which have at least one of the above shape, cross-section, size, or disposition and in which the intensity of the harmful waves is maintained below the limit. In another embodiment, the counter unit may incorporate at least one material of which magnetic permeability is different from that of the base unit or that of the target space. The solution is then used to determine a composition of matter of the material, its shape, its size, or its disposition with respect to the counter unit, base unit, and/or target space to manipulate the propagation path of the harmful and/or counter waves for the countering.

In another general aspect, the present invention relates to a portable communication system including at least one base unit defining the First Characteristics and including at least one transmitting module which irradiates harmful electromagnetic waves propagating around at least a portion of the base unit and defining an active space in which an intensity of the harmful waves exceeds a preset limit. The transmitting module serves a purpose of wireless communication by irradiating such harmful waves which carry therealong communication information, while the system forms in the active space at least one target space in which the intensity of the harmful waves is configured to be decreased below the limit. The system then comprises at least one counter unit which is configured to define the Second Characteristics and then to emit counter electromagnetic waves. At least one of the Second Characteristics is determined based on at least one solution of at least one of the Equations in such a way that the counter waves may be capable of countering at least a portion of such harmful waves through canceling at least a portion of the harmful waves in the target space or suppressing at least a portion of the harmful waves from propagating into the target space, thereby defining inside the active space the target space which encloses therein at least a substantial portion of a body of a user of the system, about a half of the body of the user, a head thereof, a brain thereof, and so on, and in which the countering decreases the intensity of the harmful waves below the limit.

Implementation of the above aspect may include one or more of the following embodiments.

In one embodiment, the system further comprises a front side and a back side, where the front side is positioned toward an ear of the user during the communication. Such a solution may be used to determine at least one of the Second Characteristics in such a way that the counter waves define the target space which spans from at least a portion of the front side and widens in a forward direction through the active space toward the user, thereby enclosing therein the portion of the body, the half of the body, the head or the brain. In another embodiment, the target space may define a shape of an enclosed conduit which extends from the front side through the active space toward the user or an open channel which traverses from the front side toward the user while separating the active space into at least two smaller active spaces. In another embodiment, the solution may be used to determine at least one of the Second Characteristics of the counter unit in such a way that the counter waves form the target space not in an opposite direction of the forward direction so as to minimize impeding the communication by the harmful waves.

In another general aspect, the present invention also relates to an areal communication system including at least one base unit defining the First Characteristics and including at least one transmitting module which irradiates harmful electromagnetic waves propagating around at least a portion of the base unit and defining an active space in which an intensity of the harmful waves exceeds a preset limit. The transmitting module serves a purpose of wireless communication by irradiating such harmful waves which carry therealong communication information, and the base unit is disposed on a tower, a pole or a mast. The system forms in the active space at least one target space in which the intensity of the harmful waves is decreased below the limit. Such a system comprises at least one counter unit which is configured to define the Second Characteristics and to emit counter electromagnetic waves. At least one of the Second Characteristics is then determined based upon at least one solution of at least one of the Equations in such a way that the counter waves are capable of countering at least a portion of the harmful waves through canceling at least a portion of the harmful waves in the target space or suppressing at least a portion of the harmful waves from propagating into the target space, thereby defining inside the active space the target space which encloses therein a geographic area, at least one country, at least one city, at least one district, at least one city block, at least one building or at least one house and in which the countering may decrease the intensity of the harmful waves below the limit.

Implementation of the above aspect may include one or more of the following embodiments.

In one embodiment, each of the tower, pole, and mast has a top and a bottom, and the counter unit is disposed below or inside of the base unit. The solution is then used to determine at least one of the Second Characteristics in such a way that the counter waves form the target space which has a shape of a sphere, a cone, a ring, a portion of any of the above, a truncation of any of the above, and a combination of any of the above, thereby enclosing the area, the country, the city, the district, the block, the building or the house therein. In another embodiment, the system may comprise a third unit which emits third electromagnetic waves and is disposed below or inside the counter unit. Such third waves are configured to counter the counter waves by canceling at least a portion of such counter waves in the target space or suppressing at least a portion of the counter waves from propagating through the target space, thereby forming the target space which has the intensity which is relatively uniform throughout the target space than the intensity obtained without the third unit.

In another general aspect, the present invention also relates to a power transmission system incorporating at least one base unit which defines the First Characteristics and which also includes at least one transmitting module irradiating harmful electromagnetic waves propagating around at least a portion of the base unit and then defining an active space in which an intensity of the harmful waves exceeds a preset limit. The transmitting module serves a purpose of wireless power transmission by irradiating the harmful waves which carry therealong electromagnetic power. The system forms in the active space at least one target space in which the intensity of the harmful waves is configured to be decreased below the limit. Such a system comprises at least one counter unit which is configured to define the Second Characteristics and to emit counter electromagnetic waves. At least one of such Second Characteristics is determined based on at least one solution of at least one of the Equations in such a way that the counter waves are capable of countering at least a portion of the harmful waves through canceling at least a portion of the harmful waves in the target space or suppressing at least a portion of the harmful waves from propagating into the target space, thereby defining inside the active space the target space which encloses at least one building, at least one house or at least one room and in which the countering decreases the intensity of the harmful waves below the limit.

Implementation of the above aspect may include one or more of the following embodiments.

In one embodiment, the solution is used to determine at least one of the Second Characteristics in such a way that the counter waves form the target space in multiple portions of the building, house or room which warrant frequent contact with persons and the counter waves perform the countering at most minimally in the rest of the building, house or room which warrants the least contact with the persons to allow the power transmission. In another embodiment, the solution is used to determine at least one of the Second Characteristics in such a way that the counter waves perform the countering at most minimally in a ceiling, a wall, a space between the walls, a crawl space or a dead space of the building, house or room.

In another general aspect, the present invention also relates to a system which is provided for a preset purpose and configured to irradiate first and second electromagnetic waves and to define a target space. The system comprises at least one wave source which is configured to function as a source of both of the first and second waves and to define therein at least one base unit and at least one counter unit. The base unit is configured to have the First Characteristics, and to irradiate the first waves. The counter unit is configured to define the Second Characteristics and to emit such second waves. At least one solution of at least one of the Equations is obtained and then used to determine at least one of the Second Characteristics in such a way that the second waves may counter at least a portion of the first waves by canceling at least a portion of the first waves in the target space and/or suppressing at least a portion of the first waves from propagating into the target space, whereby an intensity of both of the first and second waves is decreased by a preset extent in the target space. It is appreciated that the first waves typically correspond to the harmful waves described hereinabove and hereafter, while the second waves typically correspond to the counter waves also described hereinabove and hereinafter. It is therefore understood that the base and counter units may irradiate and emit such first and second (or harmful and counter) waves, respectively, to serve the purpose of the system. In the alternative, it is also understood that only the base unit irradiates the first or harmful waves to serve the purpose of the system, while the counter unit emits the second or counter waves which at least partially impedes the purpose of the system.

Implementation of the above aspect may include one or more of the following embodiments.

In one embodiment, the Equations are expressed in a differential form in terms of free charge and current, a differential form in terms of total charge and current, an integral form in terms of free charge and current, or an integral form in terms of total charge and current. The solution may be an analytical or numerical solution of at least one of the Equations, an approximation (or simplification) of at least one of the solutions, an analytical or numerical solution of an approximation (or simplification) of at least one of the Equations, or a combination of any of the above.

In another embodiment, the first waves define frequencies which are mainly one of less than about 1 kHz, between about 1 kHz and about 1 MHz, between about 1 MHz and about 1 GHz, higher than about 1 GHz, and so on. The solution may then be used to determine at least one of the Second Characteristics in such a way that the second waves have frequencies which at least partially match those of the first waves and perform the countering by the preset extent. In another embodiment, the second waves perform the countering over an entire frequency range of the first waves, over only a single portion of the range thereof or in a plurality of portions of the range thereof.

In another embodiment, the solution may also be used to determine at least one of the Second Characteristics in such a way that the counter unit performs the countering which may be completely, at least substantially or at most partially impeding the purpose, which may be mainly neutral to such a purpose or which may be at most partially, at least substantially or completely facilitating the purpose.

In another embodiment, the solution may be used so as to determine at least one of the Second Characteristics in such a way that the counter unit is disposed in various dispositions, a first of which is formed between the target space and base unit in which the second waves define amplitudes less than those of the first waves, a second of which is defined on an opposite side of the target space relative to the base unit where the second waves define amplitudes enough to perform the countering by the extent, a third of which is positioned at a first distance from a center of the target space where the first distance is neither substantially greater nor less than a second distance from the base unit to the center and where the second waves define amplitudes enough to perform the countering by the extent, a fourth of which is defined at a third distance from the center of the target space where the second waves have amplitudes which are enough to perform the countering by the extent, where the third distance is one of substantially greater and substantially less than the second distance.

In another embodiment, the solution may be used so as to determine at least one of the Second Characteristics in such a way that the counter unit defines the target space in various zones. Such a target space may be a two-dimensional first zone formed in a preset relation to the counter unit. The target space may be a three-dimensional second zone formed in another preset relation to the counter unit. The target space may be a third zone which is formed about at least a portion of the counter unit. The target space may be a fourth zone defined along at least a portion of the counter unit. The target space may be a fifth zone defined about at least one side of the counter unit. The target space may be a sixth zone defined lateral or side by side to at least a portion of the counter unit. The target space may be a seventh zone formed angularly about at least a portion of the counter unit. The target space may be an eighth zone defined on or over at least a portion of the counter unit. The target space may be a ninth zone defined in an elevation similar to at least a portion of the counter unit. The target space may be a tenth zone defined below or under at least a portion of the counter unit.

In another embodiment, the solution may be used so as to determine at least one of the Second Characteristics in such a way that the target space is configured to define an open space or a closed space. The wave source then serves the purpose only about a preset angle thereabout relative to the open target space, or the wave source serves the purpose outside the closed target space.

In another embodiment, the base unit defines various shapes such as, e.g., a curvilinear wire, a curvilinear coil or spiral, a ring, a curvilinear mesh, a curvilinear sheet or strip, a curvilinear cylinder, rod or tube, a sphere, a bead, a solenoid, a toroid, a truncation of any of the above, a fraction of any of the above, and a combination thereof. The solution may then be used to determine at least one of the Second Characteristics in such a way that the counter unit is configured to define at least one of such shapes while emitting the second waves capable of performing the countering by the extent. In another embodiment, the base unit is made of or includes therein an electrically conductive material, an electrically semiconductive material, and/or an electrically insulative material. The solution is then used to determine at least one of the Second Characteristics in such a way that the counter unit includes at least one of the materials and emits the second waves which perform the countering by the extent.

In another embodiment, the Second Characteristics may also include a direction of the second electric current, a phase angle of the second electric current, and a direction of propagation of the second waves. The solution may then be used to determine at least one of the propagation direction, current direction, and angle, depending on whether the second waves are performing the countering mainly by either of the canceling and suppressing.

In another embodiment, the solution may be used so as to determine at least one of the Second Characteristics in such a way that a second vector representing a net flux of the second waves may be configured to at least partially cancel a first vector representing a net flux of the first waves in the target space. In another embodiment, the solution may be used so as to determine at least one of the Second Characteristics in such a way that the second waves may mainly cancel at least a portion of the first waves in the target space and, thus, decrease the intensity of both of the first and second waves by the extent therein. In this embodiment, the system may be a sound generating device, an electric heating device, an electricity generating device, a device generating an electromotive force, an electric light emitting unit, and the like.

In another embodiment, the solution may be used so as to determine at least one of the Second Characteristics in such a way that a second vector representing a net flux of the second waves may be configured to at least partially oppose a first vector representing a net flux of the first waves in the target space. In another embodiment, the solution may be used to determine at least one of the Second Characteristics in such a way that the second waves primarily suppress at least a portion of the first waves from propagating into the target space and then decrease the intensity of both of the first and second waves by the extent therein. In such an embodiment, the system is a personal communication device, an areal communication device, a power transmission device, and the like. In this embodiment, the solution may be used to determine at least one of the Second Characteristics in such a way that the target space encloses at least a portion of a preset region, while the wave source is substantially capable of serving the purpose outside the target space. In this embodiment, the system is a sound generating device, an electric heating device, an electricity generating device, a device generating an electromotive force, an electric light emitting unit, and the like.

In another embodiment, the counter unit may be provided in various dispositions. The base unit and counter unit may be provided in different regions of the wave source in the first disposition, while the base unit and counter unit are provided in one region of the wave source but one over the other in the second disposition. At least a portion of one of the base and counter units may enclose at least a portion of another unit in the third disposition, while at least portions of the base and counter units may intertwine each other in the fourth disposition. At least portions of the base and counter units may be disposed side by side in the fifth disposition, while at least a portion of one of the base and counter units may wind about at least a portion of another unit in the sixth disposition.

In another embodiment, the solution may be used in order to change at least one of the Second Characteristics in response to at least one change in at least one of the First Characteristics, thereby performing the countering by the extent despite the change. In another embodiment, at least a portion of the counter unit may be in a stationary or mobile arrangement with respect to the base unit so that the solution is used to modify at least one of the Second Characteristics or move at least a portion of the counter unit in such a way to ensure the second waves to perform the countering by the extent. In another embodiment, the counter unit includes at least one material of which magnetic permeability is different from that of the base unit or that of the target space. The solution is then used to determine a composition of matter of the material, its shape, its size or its disposition with respect to the counter unit, base unit, and/or target space to manipulate propagation path of such first and/or second waves for the countering.

In another general aspect, the present invention relates to a portable communication system which is used for wireless communication and configured to irradiate first electromagnetic waves and second electromagnetic waves and to form a target space. The system comprises at least one wave source which is configured to function as a source of both the first and second waves and to define at least one base unit and at least one counter unit therein. The base unit has at least one transmitting module and irradiates the first waves which carry information for the communication therealong. The counter unit is configured to define the Second Characteristics and then to emit the second waves. At least one solution of at least one of the Equations is obtained and used to determine at least one of the Second Characteristics in such a way that the second waves are capable of countering at least a portion of the first waves through canceling at least a portion of the first waves in the target space or suppressing at least a portion of the first waves from propagating into the target space, whereby the second waves form the target space which encloses therein a geographic area, at least one country, at least one city, at least one district, at least one city block, at least one building, or at least one house and in which an intensity of both of the first and second waves is decreased by a preset extent.

Implementation of the above aspect may include one or more of the following embodiments.

In one embodiment, the system further comprises a front side and a back side, where the front side is positioned toward an ear of the user during the communication. Such a solution may be used to determine at least one of the Second Characteristics in such a way that the second waves form the target space which spans from at least a portion of the front side and widens in a forward direction toward the user, thereby enclosing therein the portion of the body, the half of the body, the head or the brain. In another embodiment, the target space defines a shape of an enclosed conduit extending from the front side toward the user through the active space. Alternatively, the target space defines a shape of an open channel traversing from the front side and across the active space while dividing such into at least two separate smaller active spaces. In another embodiment, the solution is used to determine at least one of the Second Characteristics in such a way that the second waves may form the target space not along an opposite direction of the forward direction in order to minimize impeding the communication by the first waves.

In another general aspect, the present invention also relates to an areal communication system which is used for wireless communication and configured to irradiate first electromagnetic waves and second electromagnetic waves and to form a target space. The system comprises at least one wave source which is configured to function as a source of both the first and second waves and to define at least one base unit and at least one counter unit therein. The base unit has at least one transmitting module which is incorporated on a tower, a pole or a mast and configured to irradiate the first waves which carry therealong information for the communication. The counter unit is configured to define the Second Characteristics and then to emit the second waves. At least one solution of at least one of the Equations is obtained and used to determine at least one of the Second Characteristics in such a way that the second waves are capable of countering at least a portion of the first waves by canceling at least a portion of the first waves inside the target space or suppressing at least a portion of the first waves from propagating into the target space, whereby the second waves define the target space which encloses therein a geographic area, at least one country, at least one city, at least one district, at least one city block, at least one building or at least one house and in which an intensity of both of the first and second waves is decreased by a preset extent.

Implementation of the above aspect may include one or more of the following embodiments.

In one embodiment, each of the tower, pole, and mast has a top and a bottom, and the counter unit is incorporated below or inside of the base unit. The solution is then used to determine at least one of the Second Characteristics of the counter unit in such a way that the second waves form the target space which defines a shape of a sphere, a cone, a ring, a portion of the sphere, cone or ring, a truncation of any of the above, and a combination any of the above, thereby enclosing therein the area, country, city, district, block, building or house. In another embodiment, the system comprises an additional third unit which emits third electromagnetic waves and which is positioned below or inside the counter unit. The third waves are configured to counter the second waves by canceling at least a portion of the second waves inside the target space or suppressing at least a portion of the second waves from propagating through the target space, thereby forming the target space which defines the intensity which is relatively uniform throughout the target space than another intensity which may be obtained without the third unit.

In another general aspect, the present invention also relates to a power transmission system which is used for wireless power transmission and which is configured to irradiate first and second electromagnetic waves and to form a target space. The system comprises at least one wave source which is configured to function as a source of both the first and second waves and to define at least one base unit and at least one counter unit therein. The base unit has therein at least one transmitting module which is configured to irradiate the first waves carrying therealong electromagnetic power for the power transmission. The counter unit is configured to define the Second Characteristics and then to emit the second waves. At least one solution of at least one of the Equations is obtained and used to determine at least one of the Second Characteristics in such a way that the second waves may be capable of countering at least a portion of the first waves through canceling at least a portion of the first waves in the target space or suppressing at least a portion of the first waves from propagating into the target space, whereby the second waves form the target space which encloses therein at least one building, at least one house or at least one room and in which an intensity of both of the first and second waves is decreased by a preset extent.

Implementation of the above aspect may include one or more of the following embodiments.

In one embodiment, the solution is used to determine at least one of the Second Characteristics of the counter unit in such a way that the second waves form the target space in multiple portions of the building, house or room which warrant frequent contact with persons, while the second waves perform the countering at most minimally in the rest of the building, house or room which warrants the least contact with persons to allow the power transmission. In another embodiment, the solution may be used to determine at least one of the Second Characteristics of the counter unit in such a way that the second waves perform the countering at most minimally in a ceiling, a wall, a space between the walls, a crawl space or a dead space of the building, house, and room.

In another general aspect, the present invention also relates to a system which is provided for a preset purpose and configured to irradiate first and second electromagnetic waves and to define a target space. Such a system comprises at least one wave source which is configured to function as a source of both of the first and second waves, and to define at least one base unit and at least one counter unit therein. The base unit is configured to define the First Characteristics and to irradiate the first waves which propagate about at least a portion of the base unit and then define an active space where an intensity of the first waves exceeds a preset limit. The counter unit is configured to define the Second Characteristics and to emit the second waves. At least one solution of at least one of the Equations is obtained and used to determine at least one of the Second Characteristics in such a way that the second waves are capable of countering at least a portion of the first waves by canceling at least a portion of the first waves inside the target space or suppressing at least a portion of the first waves from propagating into the target space. Therefore, the second waves define inside the active space the target space which defines a preset shape having a preset cross-section, a preset size, and a preset disposition and in which the intensity of both of the first and second waves is maintained below the limit.

Implementation of the above aspect may include one or more of the following embodiments.

In one embodiment, the solution is used to determine at least one of the Second Characteristics in such a way that the second waves may perform the countering which may be completely, at least substantially impeding or at most partially impeding the first waves from serving the purpose, which may be mainly neutral to the first waves in serving the purpose or which may be at most partially, at least substantially or completely facilitating the first waves in serving the purpose.

In another embodiment, the solution may be used so as to determine at least one of the Second Characteristics in such a way that the intensity of the first waves in the target space is below the limit but is still greater than a minimum threshold enough to serve the purpose so that the base unit at least minimally serve the purpose in at least a substantial portion of the target space, while the counter unit performs the countering therein. In another embodiment, the solution is used to determine at least one of the Second Characteristics in such a way that the intensity of the first waves in the target space is below the limit but defines various distributions, where the intensity is greatest near a boundary of the target space in the first distribution, where the intensity may be at least partly uniform in a substantial portion of the target space in the second distribution, where the intensity is lowest near the counter unit in the third distribution, and where the intensity is lowest between at least two of multiple counter units in the fourth distribution.

In another embodiment, the solution may be used so as to determine at least one of the Second Characteristics in such a way that the target space has a cross-section which defines one of various two-dimensional shapes such as a triangle, a square, a diamond, a rectangle, a trapezoid, a polygon having at least five sides, a polygon with at least one curved side, a circle, an annulus, a crescent, an ellipse, an oval, a shape with at least one parabolic side, a shape with at least one hyperbolic side, a shape with an arcuate side, a lemniscate, an astroid, a lune, a deltoid, a fraction of any of the above, a truncation of any of the above, any of the above shapes having at least one rounded corner, and a combination of any of the above. In another embodiment, the solution is used to determine at least one of the Second Characteristics in such a way that the target space may form a volume which defines at least one of various three-dimensional shapes such as a sphere, a hemisphere, a cone, a cube, a polyhedron, an ellipsoid, a three-dimensional volume obtained by translating, rotating, and/or revolving at least one of the above two-dimensional shapes, a truncation of any of the above, a fraction of any of the above, and a combination of any of the above.

In another embodiment, the solution may be used so as to determine at least one of the Second Characteristics in such a way that the target space is formed in one of many dispositions. In the first disposition, the target space is completely enclosed within the active space, while the target space is partially enclosed by the active space and open through a single portion a border or boundary of the active space toward an exterior of the active space in the second disposition. In the third disposition, the target space traverses through the target space while defining a conduit therethrough, while the target space traverses through the space while dividing the active space into at least two separate smaller active spaces in the fourth disposition.

In another embodiment, the counter unit is provided in a contiguous or separate configuration. In the contiguous configuration, at least a portion of the counter unit may be incorporated to the wave source such that the base and counter units are physically or electrically contiguous. In the separate configuration, at least a portion of the counter unit is disposed separately from the wave source such that the counter unit is physically or electrically separate from the base unit. In another embodiment, the base unit includes an electrically conductive material, an electrically semiconductive material or an electrically insulative material. The solution may then be used to determine at least one of the Second Characteristics in such a way that the counter unit is configured to incorporate at least one of such materials and to form the target space which defines at least one of the above shape, cross-section, size, and disposition and in which the intensity of both of the first and second waves is maintained below the limit.

In another embodiment, the solution may be used so as to determine at least one of the Second Characteristics in such a way that the target space defines one of various sizes. Such a target space may have the first size which is as large as the active space, the second size which is smaller than the active space, the third size corresponding to a size of at least one corner of the active space, the fourth size as large as at least one strip extending across at least a portion of the active space, and the like. The target space ay have the fifth size enough to enclose therein a preset local geographic area, the sixth size enough to enclose therein at least two people, the seventh size smaller than the sixth size but large enough to enclose therein a single user of the system, the eighth size enough to enclose therein a substantial portion of a body of the user, the ninth size enough to enclose therein about one half of the body of the user, the tenth size enough to enclose therein a head of the user, and an eleventh size enough to enclose a brain of the user.

In another embodiment, the Second Characteristics include a direction of the second electric current, a phase angle of the second electric current, a propagation direction of the second waves, and the like. The solution is used to determine at least one of the second angle, current direction, and propagation direction in such a way to determine whether the second waves perform the countering mainly by either of the canceling and suppressing.

In another embodiment, the solution may be used so as to determine at least one of the Second Characteristics in such a way that the second waves may mainly cancel at least a portion of the first waves in the target space in order to define the target space which has one of the sizes in which the intensity of both of the first and second waves is to be maintained below the limit. In this embodiment, the system is a sound generating device, an electric heating device, an electricity generating device, a device generating an electromotive force or an electric light emitting unit. The solution is then used to determine at least one of the Second Characteristics, thereby defining the target space which has the first, second, third, fourth, sixth, seventh, eighth, ninth, tenth or eleventh size.

In another embodiment, the solution may be used so as to determine at least one of the Second Characteristics in such a way that the second waves primarily suppress at least a portion of the first waves from propagating into the target space in order to define the target space which defines one of the sizes in which the intensity of both of the first and second waves is maintained below the limit. In this embodiment, the system is a personal communication device, an areal communication device or a power transmission device. The solution may then be used to determine at least one of the Second Characteristics and to form the target space defining the second, third, fourth, sixth, seventh, eighth, ninth, tenth or eleventh size for the personal communication device. The solution may instead be used to determine at least one of the Second Characteristics and to form the target space defining the first, second, third, fourth, fifth or sixth size for the areal communication device or to form the target space of the first, second, third, fourth, fifth, sixth, seventh, eighth or ninth size for the power transmission device. In this embodiment, the system may be a sound generating device, an electric heating device, an electricity generating device, a device generating an electromotive force or an electric light emitting unit. The solution is then used to determine at least one of the Second Characteristics and to form the target space with the first, second, third, fourth, sixth, seventh, eighth, ninth, tenth or eleventh size.

In another embodiment, the counter unit is provided one of various dispositions. The base unit and counter unit are provided in different regions of the wave source in the first disposition, while the base unit and counter unit are provided in one region of the wave source but one over the other in the second disposition. At least a portion of one of the base and counter units encloses at least a portion of another unit in the third disposition, while at least portions of the base and counter units intertwine each other in the fourth disposition. At least portions of the base and counter units are disposed side by side in the fifth disposition, while at least a portion of one of the base and counter units wind about at least a portion of another unit in the sixth disposition.

In another embodiment, the solution may be used in order to change at least one of the Second Characteristics in response to at least one change in at least one of the First Characteristics, thereby defining the target space which have at least one of the shape, cross-section, size, and disposition and where the intensity of both of the first and second waves is maintained below the limit.

In another embodiment, at least a portion of the counter unit is in a stationary or mobile arrangement with respect to the base unit so that the solution is used to modify at least one of the Second Characteristics in the stationary arrangement or to move at least a portion of the counter unit in the mobile arrangement in such a way to ensure the second waves to define the target space which also defines at least one of the shape, cross-section, size, and disposition and in which the intensity of both of the first and second waves is maintained below the limit.

In another embodiment, the counter unit may include at least one material of which magnetic permeability is different from that of the base unit or that of the target space. The solution is used to determine at least one of a composition of matter of the material, its shape, its size, and its disposition with respect to the counter unit, base unit, and/or target space so as to manipulate propagation path of at least one of the first and second waves for the countering.

In another general aspect, the present invention relates to a portable communication system which is used for wireless communication and configured to irradiate first electromagnetic waves and second electromagnetic waves and to form a target space. The system comprises at least one wave source which is configured to function as a source of both the first and second waves and to define at least one base unit and at least one counter unit therein. The base unit has at least one transmitting module and is configured to irradiate the first waves which are configured to carry information for the communication therealong and to define an active space in which an intensity of the first waves is to exceed a preset limit. The counter unit is configured to define the Second Characteristics and to emit the second waves. At least one solution of at least one of the Equations is obtained and then used to determine at least one of the Second Characteristics in such a way that the second waves may be capable of countering at least a portion of the first waves through at least one of canceling at least a portion of the first waves in the target space or suppressing at least a portion of the first waves from propagating into the target space, whereby the second waves form inside the active space the target space which encloses therein a substantial portion of a body of a user of the system, about a half of the body of the user, a head thereof or a brain thereof and where the intensity of both of the first and second waves is maintained below the limit.

Implementation of the above aspect may include one or more of the following embodiments.

In one embodiment, the system further comprises a front side and a back side, where the front side is positioned toward an ear of the user during the communication. The solution may then be used to determine at least one of the Second Characteristics in such a way that the second waves form the target space which spans from at least a portion of the front side and then widens in a forward direction toward the user, thereby enclosing therein the above portion of the body, half of the body, head or brain. In a related embodiment, the target space forms a shape of an enclosed conduit which extends from the front side toward the user through the active space or a shape of an open channel which traverses from the front side through the active space while dividing the active space into at least two separate smaller active spaces. In another embodiment, the solution is used to determine at least one of the Second Characteristics in such a way that the second waves form the target space not in an opposite direction of the forward direction in order to minimize impeding the communication by the first waves.

In another general aspect, the present invention relates to an areal communication system that is used for wireless communication and also configured to irradiate first and second electromagnetic waves and to define a target space. The system comprises at least one wave source which may be configured to function as a source of both of the first and second waves and to define at least one base unit and at least one counter unit therein. The base unit includes at least one transmitting module which is incorporated on a tower, a pole or a mast, and configured to irradiate the first waves which carry therealong information for the communication and to define an active space in which an intensity of the first waves is to exceed a preset limit. The counter unit may be configured to have the Second Characteristics and to emit the second waves. At least one solution of at least one of the Equations is obtained and then used to determine at least one of the Second Characteristics in such a way that the second waves are capable of countering at least a portion of the first waves by canceling at least a portion of the first waves in the target space and/or suppressing at least a portion of the first waves from propagating into the target space, whereby the second waves form inside the active space the target space which encloses therein a geographic area, at least one country, at least one city, at least one district, at least one city block, at least one building, at least one house, and the like, and in which the intensity of both of the first and second waves is maintained below the limit.

Implementation of the above aspect may include one or more of the following embodiments.

In one embodiment, each of the tower, pole, and mast has a top and a bottom. The counter unit is incorporated below or inside of the base unit, and the solution is used to determine at least one of the Second Characteristics of the counter unit in such a way that the second waves may form the target space which defines a shape of a sphere, a cone, a ring, a portion of the sphere, cone or ring, a truncation of any of the above, and a combination of any of the above, thereby enclosing therein the area, country, city, district, block, building or house. In another embodiment, the system comprises a third unit which emits third electromagnetic waves. When the third unit is positioned below or inside the counter unit, the third waves are configured to counter the second waves by canceling at least a portion of the second waves in the target space and/or suppressing at least a portion of the second waves from propagating through the target space, thereby forming such a target space in which the intensity is relatively uniform throughout the target space than the intensity obtained without the third unit.

In another general aspect, the present invention relates to a power transmission system which is used for wireless power transmission and configured to irradiate first and second electromagnetic waves and to define a target space. The system may comprise at least one wave source which is configured to function as a source of both of the first and second waves and to define at least one base unit and at least one counter unit therein. The base unit includes therein at least one transmitting module which irradiates the first waves which carry therealong electromagnetic power for the power transmission and forms an active space in which an intensity of the first waves is to exceed a preset limit. The counter unit is configured to define the Second Characteristics and then to emit the second waves. At least one solution of the Equations is obtained and utilized to determine at least one of the Second Characteristics in such a way that the second waves may be capable of countering at least a portion of the first waves through canceling at least a portion of the first waves in the target space or suppressing at least a portion of the first waves from propagating into the target space, whereby the second waves define inside the active space the target space which encloses therein at least one building, house or room and in which the intensity of both of the first and second waves is maintained below the limit.

Implementation of the above aspect may include one or more of the following embodiments.

In one embodiment, the solution is used to determine at least one of the Second Characteristics of the counter unit in such a way that the second waves form the target space in multiple portions of the building, house or room which warrant frequent contact with persons, while such second waves perform the countering at most minimally in the rest of the building, house or room which warrants the least contact with persons to allow the power transmission. In another embodiment, the solution is used to determine at least one of the Second Characteristics in such a way that the second waves perform the countering at most minimally in a ceiling, a wall, a crawl space, a space between such walls or a dead space of the building, house or room.

In another general aspect, the present invention relates to a method of irradiating harmful electromagnetic waves for serving a preset primary purpose while decreasing an intensity of the harmful waves in a target space. The method comprises the steps of: selecting the target space; assessing a radiative pattern of the harmful waves in the target space; determining a radiative pattern of counter electromagnetic waves capable of countering the harmful waves by at least one of canceling at least a portion of the harmful waves therewith in the target space and suppressing at least a portion of the harmful waves therewith from propagating into the target space; and emitting the counter waves, thereby accomplishing the decreasing.

Implementations of the above aspect may include one or more of the following features.

In one feature, the determining comprises the step of solving at least one of multiple equations which includes Gauss law, Gauss law for magnetism, Faraday's law of induction, Ampere's circuital law, and Lorentz force law using characteristics of the target space and/or radiative pattern of such harmful waves as an initial condition, a boundary condition, and/or a constitutive equation. In another feature, the solving comprises at least one of the following steps of: analytically solving at least one of the equations; simplifying at least one of the equations and then analytically solving the simplified equation; approximating at least one of the equations and then analytically solving the approximated equation; numerically solving at least one of the equations; simplifying at least one of the equations and then numerically solving the simplified equation; approximating at least one of the equations and then numerically solving the approximated equation; and performing at least two of such analytically solving, simplifying, approximating, and numerically solving. In another feature, the above decreasing comprises at least one of the steps of: decreasing the intensity by a preset extent which is a ratio of a first intensity of the harmful waves after being countered by the above counter waves to a second intensity of the harmful waves without such countering; and decreasing the intensity below a preset limit which may be defined as an intensity of electric waves of the harmful waves or an intensity of magnetic waves of the harmful waves. In another feature, the decreasing comprises at least one of the steps of: reducing the above intensity by the extent in entire portion of the target space; reducing an average of the intensity in the target space by the extent; keeping the intensity below such a limit in entire portion of the target space; and keeping an average of the intensity in the target space below the limit, where the average is an arithmetic average, a geometric average, an ensemble average or a weighted average. In another feature, the countering may be for at least one of: completely impeding the serving; at least substantially impeding the serving; at most minimally impeding the serving; at most minimally facilitating the serving; at least substantially facilitating the serving; and completely facilitating the serving. In another feature, the determining comprises one of the steps of: configuring the counter waves in such a way that, when the counter waves are not propagated, the intensity decreases but that the purpose is less served by the harmful waves; configuring the counter waves in such a way that, when the counter waves are not propagated, the purpose is served by such harmful waves but that the intensity is less decreased.

In another general aspect, the present invention relates to a method of decreasing an intensity of harmful electromagnetic waves inside a target space, where the harmful waves may define first characteristics which include at least one of a first composition of matter of a base unit irradiating the waves, a first configuration of the base unit, a first path of first electric current defined in the base unit, and first dynamic property of the first electric current which flows in the first path. This method comprises the steps of: disposing at least one counter unit based on a preset relation to the base unit; determining at least one second characteristics of the counter unit based upon at least one solution obtained by solving at least one of multiple equations including Gauss law, Gauss law for magnetism, Faraday's law of induction, Ampere's circuital law, Lorentz force law, and the like, where the second characteristics include at least one of a second composition of matter of the counter unit, a second configuration of the counter unit, a second path of second electric current defined in the counter unit, second dynamic property of the second electric current flowing in the second path, and a disposition with respect to the base unit; and emitting counter electromagnetic waves by the counter unit with the second characteristics, thereby countering the harmful waves by canceling at least a portion of the harmful waves by the counter waves in the target space and/or suppressing at least a portion of the harmful waves from propagating into the target space with the counter waves and accomplishing the decreasing.

Implementations of the above aspect may include one or more of the following features.

In one feature, the solving may comprise the step of: using at least one characteristics of the target space or at least one of first characteristics as an initial condition, a boundary condition, and/or a constitutive equation of at least one of the equations. In another feature, the solving may comprise at least one of the steps of: analytically solving at least one of the equations; simplifying at least one of the equations and then analytically solving the simplified equation; approximating at least one of such equations and then analytically solving the approximated equation; numerically solving at least one of the equations; simplifying at least one of the equations and numerically solving the simplified equation; approximating at least one of the equations and then numerically solving the approximated equation; and performing at least two of such analytically solving, simplifying, approximating, and numerically solving. In another feature, the decreasing may comprise at least one of the steps of: decreasing the intensity by a preset extent which may be defined as a ratio of a first intensity of the harmful waves after being countered by the counter waves to a second intensity of the harmful waves without the countering; and decreasing the intensity below a preset limit which is defined as at least one of an intensity of electric waves of the harmful waves and an intensity of magnetic waves of the harmful waves. In another feature, the decreasing may comprise at least one of the steps of: reducing the intensity by the extent in entire portion of the target space; reducing an average of the intensity in the target space by the extent; keeping the intensity below the limit in entire portion of the target space; and keeping an average of the intensity in the target space below the limit, where the average may be defined as above. In another feature, the method may further comprise the steps of: performing the irradiating for a preset purpose; and configuring the countering to be completely against the purpose, at least substantially against the purpose, at most minimally against the purpose, substantially neutral to the purpose, at most minimally facilitating the purpose, at least substantially facilitating the purpose, or completely facilitating the purpose. In another feature, the determining comprises one of the steps of: configuring the counter waves in such a way that, when the counter waves are not propagated, the intensity decreases but that the purpose is less served by the harmful waves; and configuring the counter waves in such a way that, when the counter waves are not propagated, the purpose may be served by the harmful waves but that the intensity is less decreased.

In another general aspect, the present invention relates to a method of decreasing an intensity of a sum of at least two different electromagnetic waves irradiated or emitted by at least two different units in a target space, while irradiating at least first one of the waves for a preset purpose and while emitting at least second one of the waves for the decreasing. Such a method comprises the steps of: selecting the target space; assessing a radiative pattern of the first waves inside the target space; determining a radiative pattern of the second waves which are capable of countering the first waves by canceling at least a portion of the first waves therewith in the target space and/or suppressing at least a portion of the first waves therewith from propagating into the target space; and propagating the first and second waves in preset directions in such a way that the intensity is decreased in the target unit.

Implementations of the above aspect may include one or more of the following features.

In one feature, the propagating comprises one of the steps of: arranging an amplitude of the first waves to be greater than that of the second waves; arranging amplitudes of the first and second waves to be similar to each other; and arranging an amplitude of the second waves to be greater than that of the first waves. In another feature, the determining comprises the step of: solving at least one of a plurality of equations including Gauss law, Gauss law for magnetism, Faraday's law of induction, Ampere's circuital law, Lorentz force law, and the like, using characteristics of the target space or the radiative pattern of such harmful waves as an initial condition, a boundary condition, or a constitutive equation. In another feature, the solving comprises at least one of the steps of: analytically solving at least one of the equations; simplifying at least one of the equations and then analytically solving the simplified equation; approximating at least one of the equations and then analytically solving the above approximated equation; numerically solving at least one of the equations; simplifying at least one of the equations and numerically solving the simplified equation; approximating at least one of the equations and then numerically solving the approximated equation; and performing at least two of the analytically solving, simplifying, approximating, and numerically solving. In another feature, the above decreasing comprises at least one of the steps of: decreasing the intensity by a preset extent which is defined as a ratio of a first intensity of the harmful waves after they are countered by the counter waves to a second intensity of the harmful waves without the countering; and decreasing the intensity below a preset limit which is defined as an intensity of electric waves of the harmful waves or an intensity of magnetic waves of the harmful waves. In another feature, the decreasing comprises at least one of the steps of: reducing the intensity by such an extent in entire portion of the target space; reducing an average of the intensity in the target space by the extent; keeping the intensity below the limit in entire portion of the target space; and keeping an average of the intensity in the target space below the limit, where the average has been described hereinabove. In another feature, the countering may be for at least one of: completely impeding such serving; at least substantially impeding such serving; at most minimally impeding the serving; at most minimally facilitating the serving; at least substantially facilitating the serving; and completely facilitating the serving. In another feature, the determining comprises one of the steps of: configuring the second waves in such a way that, when the second waves are not propagated, the intensity decreases but that the purpose may be less served by the first waves; and configuring the second waves in such a way that, when the second waves are not propagated, the purpose is served by the first waves but that the intensity may be less decreased.

In another general aspect, the present invention relates to a method of decreasing an intensity of a sum of at least two different electromagnetic waves irradiated or emitted by at least two different units inside a target space. The method comprises the steps of: determining radiative patterns of the electromagnetic waves; manipulating at least one wave characteristics of second of the waves so that the second waves are capable of countering first of the waves by canceling at least a portion of the first waves with the second waves inside the target space and/or suppressing at least a portion of the first waves with the second waves from propagating into the target space, where the above manipulating is performed based on at least one solution obtained by solving at least one of a plurality of equations including Gauss law, Gauss law for magnetism, Faraday's law of induction, Ampere's circuital law, and Lorentz force law; and propagating both of the first and second waves at least one of toward, around, near, and in the target space, thereby accomplishing the decreasing.

Implementations of this aspect may be similar or identical to those of the above method aspects of the present invention.

In another general aspect, the present invention relates to a method of decreasing an intensity of at least two different electromagnetic waves irradiated and emitted from at least two different units in a target space, where first of the waves define first characteristics which include at least one of a first composition of matter of a first of the units, a first configuration of the first unit, a first path of first electric current which is defined in the first unit, and first dynamic property of the first electric current flowing in the first path. The method comprises the steps of: disposing a second of the units based on a preset relation to the first unit; determining at least one second characteristics of the second unit based upon at least one solution obtained by solving at least one of multiple equations including Gauss law, Gauss law for magnetism, Faraday's law of induction, Ampere's circuital law, and Lorentz force law, where the second characteristics may include at least one of a second composition of matter of the second unit, a second configuration of the second unit, a second path of second electric current defined in the second unit, second dynamic property of the second electric current which flows in the second path, and a disposition with respect to the second unit; emitting second of the waves by the second unit, thereby countering the first waves by canceling at least a portion of the first waves by the second waves inside the target space or suppressing at least a portion of the first waves from propagating into the target space with the second waves and thereby accomplishing the decreasing.

Implementations of this aspect may be similar or identical to those of the above method aspects of the present invention.

Various implementations of the systems or methods described herein may include one or more of the following advantages.

The electromagnetically-countered systems (i.e., the EMC systems) constructed according to one or more aspects of this invention offer a unique advantage of effectively countering not only the electric waves (i.e., electric components of the electromagnetic waves) but also the magnetic waves (i.e., magnetic components of such waves) and then defining the target space in which intensities of both of the electric and magnetic waves are to be maintained below a preset limit. Therefore, the EMC systems of this invention provide an additional advantage of decreasing the intensity of such magnetic waves in the target space, which has not been effectively accomplished by any previous technology.

The EMC systems of this invention offer another advantage of reducing the health risks which have been reported to be associated with the electromagnetic waves irradiated by almost all electric and electronic devices. Depending upon the specific aspect of this invention, the EMC systems can form the target space which can enclose an internal or exposed organ of a user, an entire body of the user, several users, an entire building a district or a specific geographic area. Therefore, various EMC systems of this invention provide the advantage of helping industry to cope with municipal and federal regulations regarding the electromagnetic radiation as well as easing anxiety of its customers.

Various counter units to be incorporated into the EMC systems of this invention are typically no more than specific wave transmitters or transmitting modules. Therefore, each EMC system offers the advantage of incorporating therein a single or multiple counter units, where the detailed incorporation depends on shapes, sizes, operating characteristics and constraints, and the like. The EMC systems also offer the advantage of their versatility, in that they can be designed to counter the harmful waves of all frequencies or that they can be designed only to counter those waves of preset frequencies.

The EMC systems of this invention also offer the advantage of decreasing the intensity of the electromagnetic waves in the target space without sacrificing such systems from serving their own purpose. Depending on their configuration, various counter units of this invention can actually facilitate or boost the EMC systems to serve their original purposes, at least outside such a target space, while creating the target space for their users.

The EMC systems are economical, for conventional waves sources may be easily modified or converted into the counter units of this invention. In addition, such counter units may also be easily incorporated to the existing electric or electronic devices. Moreover, the conventional waves sources may be reconfigured into an assembly of one or more base unit as well as one or more counter units, without requiring an excessive overhaul of the existing electric or electronic devices. Accordingly, the EMC systems of this invention offer the advantage of countering the harmful waves or decreasing the intensity of all electromagnetic waves of specific frequencies in the target space economically.

The EMC systems of this invention further offer the advantage that they can be custom-made, depending on various characteristics of the wave sources as well as on the nature of an object to be protected from the electromagnetic waves. For example, such EMC systems can define various target spaces which have desirable configurations such as their shapes, sizes, geometries, alignments, and symmetries and which can be custom-made by various well known numerical methods such as, e.g., method of moments, finite difference time-domain method, and the like.

The EMC systems of this invention further offer the benefit of countering the harmful waves irradiated from almost all electric or electronic devices. Accordingly, the EMC systems can protect a user of personal wireless communication device such as a cellular phone or a smart phone), people residing proximate to an areal communication device such as a communication transmitting tower or a big antenna used for wireless communication, or people staying proximate to a power transmission device such as a wireless electricity charging device. Such EMC systems can also protect a user of other conventional electric or electronic devices such as, e.g., a sound generating device, an electric heating device, an electricity generating device, a device which generates an electromotive force, an electric light emitting unit, and the like.

As used herein, the term “sound generating device” refers to any electric or electronic element which is capable of generating audible sound. The sound generating device typically includes at least one speaker such as, e.g., a cone-drive speaker, a planar speaker, a bending wave speaker, a flat panel speaker, a horn speaker, a piezoelectric speaker, a magnetostrictive speaker, a digital speaker, an electrostatic speaker, a plasma arc speaker, and the like. The sound generating device also refers to any electric or electronic device incorporating therein at least one of the above speakers. Examples of such a device include, but not limited to, an earphone, a headphone, a handset of a phone, a mobile phone, a cellular phone, a smart phone, a head-mounted device, and other devices designed to deliver the audible sounds to the ear, to deliver mechanical signals toward at least one ear bone or to deliver electrical signals to at least one nerve, where such mechanical or electrical signals are converted into or recognized as the corresponding audible sounds by the ear or brain. The target space of the sound generating device generally corresponds to various zones defined near, on, in or around at least one ear of the user but, when desirable, can also be defined near, on, in, around or along a brain, a nerve or an eye of the user. As used herein, another term “sound generating system” may also be used to refer to the above sound generating device. This device is to be interchangeably referred to as an “EMC sound generating device,” an “EMC sound generating system” or simply as a “sound generating device” when supplied with at least one of various counter units of the present invention.

As used herein, the term “electric heating device” refers to any electric or electronic element which is capable of generating heat or emitting electromagnetic waves in particular frequency ranges. The electric heating device generally includes at least one heating element such as, e.g., a resistive heating element, a radiative heating element, a reflective heating element, an inductive heating element, and the like. Such heating elements can take any shapes or sizes as long as the heating elements can generate heat or emit those waves efficiently. The electric heating element also refers to any electric or electronic device which incorporates therein at least one of the above heating elements. Examples of such a device include, but not limited to, a personal heating appliance (e.g., an electric mattress, an electric mat, an electric blanket, an electric pad, an electric cloth, an electric belt, an electric shoes, and the like), a cooking appliance (e.g., an electric stove, an electric oven, an electric grill, an electric range, an electric toaster, an electric toaster oven, an electric immersion heater, an electric induction heater, and the like), and a beauty-related appliance (e.g., a hair dryer, a hair setter, a hair steamer, a hair curler, an electric cosmetic device, an electric iron, an electric steam iron, and the like). The target space of the electric heating device generally corresponds to various zones of a human body such as, e.g., the whole body, an upper torso, a lower torso, a back, a belly, extremities such as arms and legs, a hand, a foot, a head, a testicle, an intestine, an internal organ, a brain, a face, an eye, and the like. As used herein, another term “electric heating system” may be used to refer to the above electric heating device as well. This device is to be interchangeably referred to as an “EMC heating device,” an “EMC heating system” or simply as an “heating device” when supplied with at least one of various counter units of the present invention.

The term “electricity generating device” means herein any electric or electronic element which is capable of generating electric voltage gradient and/or electric current. Examples of such electricity generating device include, but not limited to, an AC generator, a DC generator, a transformer, a linear generator, a tachogenerator, an alternator, an adaptor. The target space of the electricity generating device may vary in locations and sizes depending upon main use of such a device. For example, the target space for a portable electricity generating device may correspond to one more specific organs of the user, whereas the target space for a stationary electricity generating device may correspond to the whole body of the user or a fraction thereof. The electricity generating device may also refer to any conventional or hybrid generator which is used in an electric car, a hybrid car, and a car which operates on a fuel cell. As used herein, another term “electricity generating system” may be used to refer to the above electricity generating device as well. This device is to be interchangeably referred to as an “EMC electricity generating device,” an “EMC electricity generating system” or simply as an “electricity generating device” or “generating device” when it is supplied with at least one of various counter units of the present invention.

The term “device generating an electromotive force” or the term “device capable of generating an electromotive force” means any electric or electronic element which is capable of generating force or movement in a curvilinear direction. The device generating an electromotive force typically includes at least one motor such as, e.g., a DC motor, an AC motor, an universal motor, a synchronous motor, an induction motor, a linear motor, and any other actuators which are capable of converting electrical energy into mechanical energy. The device generating an electromotive force also refers to a variety of appliances, tools, devices, and the like, where examples of such may include, but not limited to, an electric kitchen appliance (e.g., an electric knife, an electric cutter, an electric can opener, a freezer, a refrigerator, an electric cooler, a food processor, a mixer, a juicer, a grinder, a blender, a squeezer, a dish washer, and the like), an electric cooking appliance (e.g., a fan, a microwave oven, and the like), an electric household appliance (e.g., a washer, a dryer, an air conditioner, a garage opener, a dry or wet vacuum cleaner, a grass mower, a blower, a fan, a treadmill, an exercise machine, and the like), an electric tool (e.g., an electric drill, an electric jigsaw, an electric screwdriver, an electric nail gun, an electric staple gun, an electric sander, an electric pencil sharpener, an electric hammer, an electric stapler, and the like), an electric office appliance (e.g., a photocopy machine, a printer, a scanner, an electric hole puncher, a shredder, an electric cutter, and the like), an electric hygiene device (e.g., an electric razor, an electric shaver, an electric toothbrush, a hair dryer, an electric massager, and the like), an electric medical device (e.g., an electric wheel chair, an electric operation table, an electric massage unit, an electric surgical tool capable of moving and/or displacing at least a portion thereof, an electric diagnostic unit capable of moving and/or displacing at least a portion thereof, and the like). The target space of such a device also corresponds to various zones of a human body such as, e.g., the whole body, an upper torso, a lower torso, a back, a belly, extremities such as arms and legs, a hand, a foot, a head, a testicle, an intestine, an internal organ, a brain, a face, an eye, and the like. As used herein, another term “system generating an electromotive force” may also be used to refer to the above device generating an electromotive force. This device is also to be interchangeably referred to as an “EMC device generating an electromotive force,” an “EMC system generating an electromotive force” or simply as an “device generating an electromotive force” when supplied with at least one of various counter units of the present invention.

As used herein, the term “electric light emitting unit” refers to any electric or electronic element which is capable of emitting light rays of various frequencies such as, e.g., infrared rays, visible light rays, ultraviolet rays, and the like. The electric light emitting unit typically incorporates at least one light emitting element such as, e.g., an incandescent bulbs, a fluorescent bulb, a CCFL, an EEFL, a CRT, a light emitting diode, an LCD, an LED, an OLED, an IOLED, an ILED, a PDP, and the like. The electric light emitting unit also refers to any electric or electronic device which includes at least one of the above light emitting element. Examples of such a device include, but not limited to, a light bulb, a light lamp, a display panel capable of directly or indirectly emitting at least one of the above light rays, a device unit including at least one of the above light emitting elements, and any other electric or electronic devices including one or more of the above light emitting elements. The target space of such a device generally corresponds to various zones of a human body as illustrated above when the device is designed to display images to the user. Alternatively, the target space may correspond to an entire portion or only a portion of a space which is to be lighted when the above device is designed to illuminate a specific space. As used herein, another term “electric light emitting system” may be used to refer to the above electric light emitting unit as well. This device is also to be interchangeably referred to as an “EMC light emitting device,” an “EMC light emitting system” or simply as an “light emitting device” when supplied with at least one of various counter units of the present invention.

As used herein, the term “personal communication device” refers to any electric or electronic device which incorporates therein at least one transmitting module capable of wirelessly transmitting signals for unilateral, bilateral or multilateral communication. Examples of the personal communication device includes, but not limited to, a wired phone, a wireless phone, a mobile phone, a cellular phone, a smart phone, and any other portable communication equipment. The target space of such a personal communication device generally corresponds to various zones defined near, on, in or around at least one ear of the user but, when desirable, can also be defined near, on, in, around or along a brain, an eye or a nerve of the user. Since most of the personal communication devices are portable in nature, the exact location of the target space may vary depending upon a use pattern of the user as well. As used herein, another term “personal communication system” may also be used to refer to the above personal communication device.

In contrary to the above personal communication device which is mainly designed to allow an individual user to transmit his or her own signals, the term “areal communication device” refers to any electric or electronic device which incorporates therein at least one transmitting module which is not only bigger but also more powerful than that of the personal communication device. Accordingly, the areal communication device can transmit the signals to a wider space or area, e.g., across a local, regional or even global geographic space or area. Another feature of the areal communication device lies in the fact that the transmitting module of such a device is typically disposed in a higher elevation, e.g., on top of a tower, pole or mast. Accordingly, the areal communication device also refers to any signal transmission or relay tower, a signal transmission or relay pole, a signal transmission or relay antenna as used herein. The target space of the areal communication device typically corresponds to specific zones or regions formed under such a tower, pole or antenna and covers a wider space (or area) therein. As used herein, another term “areal communication system” may also be used to refer to the above areal communication device.

Similarly, the term “power transmission device” means any electric or electronic device which incorporates therein at least one transmitting module which is primarily designed to wirelessly deliver electromagnetic energy. Thus, the power transmission device differs from the areal communication device only in frequencies of the electromagnetic waves involved and/or amplitudes of such waves. It is appreciated, however, that the power transmission device may be designed to deliver the energy in a short range (e.g., wirelessly charging a battery inside a room) or in a long range (e.g., delivering the energy wirelessly from solar cells installed on a desert to a city a few miles or more apart). Therefore, the target space for the power transmission device may vary from that of the personal communication device to that of the areal communication device. As used herein, another term “power transmission system” may also be used to refer to the above power transmission device.

As used herein, the term “transmitting module” collectively refers to any electric and electronic elements which irradiate electromagnetic waves for the purpose of wireless communication, wireless power transmission, wireless data transmission, wireless networking, and the like, where the above communication, transmission or networking may be unilateral, bilateral or multilateral. Therefore, the transmitting module refers to various transmitters or antennas which can irradiate and, optionally, can receive the electromagnetic waves of particular frequencies. In this context, the transmitting module can be used interchangeably with the terms “antenna” or “base unit” throughout this disclosure. When used broadly, the transmitting module may also refer to base units of any electric or electronic devices which irradiate the harmful electromagnetic waves, where examples of such devices may include all of the above devices described heretofore.

The term “target space” generally means a two-dimensional area (zone, region or space), or more preferably designates a three-dimensional space (zone, region or area) in which an intensity of all electromagnetic waves of a specific frequency range (or that of harmful electromagnetic waves of a specific frequency range) is to be maintained below a preset value. Because a main objective of the present invention is to protect a user of a system of this invention (or a bystander) from such waves, the target space typically corresponds to a space which encloses therein an entire portion or only a portion of a body of the user. Depending upon the nature of a source of the waves, the target space may be shaped and/or sized to enclose therein only one or a few organs of the body (e.g., a typical target space of the sound generating device), an entire human body (e.g., a typical target space for the personal communication device), a few or even tens, hundreds or thousands of human bodies (e.g., a typical target space for the areal communication device). It is appreciated that the shape and size of the target space depends upon the above value, i.e., the maximum intensity of such waves in the target space, an age or susceptibility of the body to such waves, regional or national standards or regulations, and the like. It is also appreciated that the target space is defined as a space in which the intensity of the harmful electromagnetic waves or that of their magnetic waves is to be decreased by a preset extent or below a preset limit or in which the intensity of all electromagnetic waves of preset frequencies or that of their magnetic waves is to be decreased by a preset extent or below a preset limit.

In contrary, the term “active space” means a two-dimensional area (zone, region or space), or more preferably designates a three-dimensional space (zone, region or area) in which an intensity of all electromagnetic waves of a specific frequency range (or that of harmful electromagnetic waves of a specific frequency range) is to exceed a preset limit. Depending upon the nature of a source of the waves, the active space may be shaped and/or sized to enclose therein only one or a few organs of the body, an entire human body, a few or even tens, hundreds or thousands of human bodies, and the like. It is appreciated that the above limit may refer to a level of such electromagnetic waves above which various systems of this invention can perform their intended purposes. Alternatively, the above limit may simply represent a level of such waves above which the human is subject to adverse health effects or above which is beyond regional or national standards or regulations.

Other general aspects include other combinations of the aspects, embodiments, and features described above and below, and other aspects, embodiments, and features expressed as systems, apparatus, methods, program products, and in other ways.

Although the invention has been particularly shown and described with reference to the aspects and embodiments described, it will be understood by persons skilled in the relevant art that various changes in form and details can be made therein without departing from the spirit and scope of the invention.

The details of one or more aspects and their embodiments of the invention are set forth in the accompanying drawings and description below. Other aspects, embodiments, features, objectives, and advantages of the invention will be apparent from the description and the drawings, and from the claims.

### DESCRIPTION OF DRAWINGS

The following drawings, which are incorporated in and which form a part of the specification, illustrate embodiments of the present invention and, together with the description, serve to explain the principles, devices and methods described herein.

FIGS. 1A and 1B are schematic views of magnetic fluxes from a single magnetic pole (or base unit);

FIGS. 1C to 1H are schematic views of magnetic fluxes between and around multiple magnetic poles (or between a base unit and a counter unit) according to the present invention;

FIGS. 2A and 2B are schematic views of magnetic fluxes formed by electric current flowing in a single conductive path (or base unit);

FIGS. 2C to 2H are schematic views of magnetic fluxes formed by electric currents flowing in multiple conductive paths (or a base unit and a counter unit) according to the present invention;

FIGS. 3A and 3B are schematic views of harmful and counter electromagnetic fields of a base unit and a counter unit of a personal communication device, respectively;

FIGS. 3C to 3F are schematic views of target spaces of various shapes and sizes which are defined around the personal communication device according to the present invention;

FIGS. 4A and 4B are schematic views of harmful and counter electromagnetic fields of a base unit and a counter unit of an areal communication device, respectively, according to this invention; and

FIGS. 4C to 4F are schematic views of target spaces of various shapes and sizes which are defined around the areal communication device according to the present invention.

### DETAILED DESCRIPTION

Various aspects and embodiments of this invention are now described more particularly with reference to the drawings and text of this disclosure. Such aspects and embodiments, however, only represent different forms. Therefore, various systems, methods, and processes of this invention may also be embodied in many other different forms and, therefore, should not be limited to such aspects and embodiments set forth herein. Rather, various exemplary aspects and embodiments described herein are provided so that this disclosure will be thorough and complete, and fully convey the scope of this invention to one of ordinary skill in the relevant art.

Unless otherwise specified, it is understood that various members, units, elements, and parts of various aspects and embodiments of the present invention are not typically drawn to scales and/or proportions for ease of illustration. It is also appreciated that such members, units, elements, and parts of various aspects and embodiments of this invention designated by the same numerals represent the same, similar or functionally equivalent members, units, elements, and/or parts thereof, respectively.

As disclosed herein, each electromagnetically-countered system (which is referred to as the “EMC system”) includes at least one counter unit which can counter harmful electromagnetic waves emitted by at least one base unit by canceling at least a portion of the harmful waves in a target space or by suppressing at least a portion of the harmful waves from propagating into the target space. To this end, the counter unit emits counter electromagnetic waves which have desirable amplitudes and phase angles to accomplish such canceling or suppressing. Such “canceling” and “suppressing” are to be collectively referred to as the “countering” hereinafter.

In one general aspect, a mechanism of the above “countering” can be explained by resorting to basic theories of magnetism.

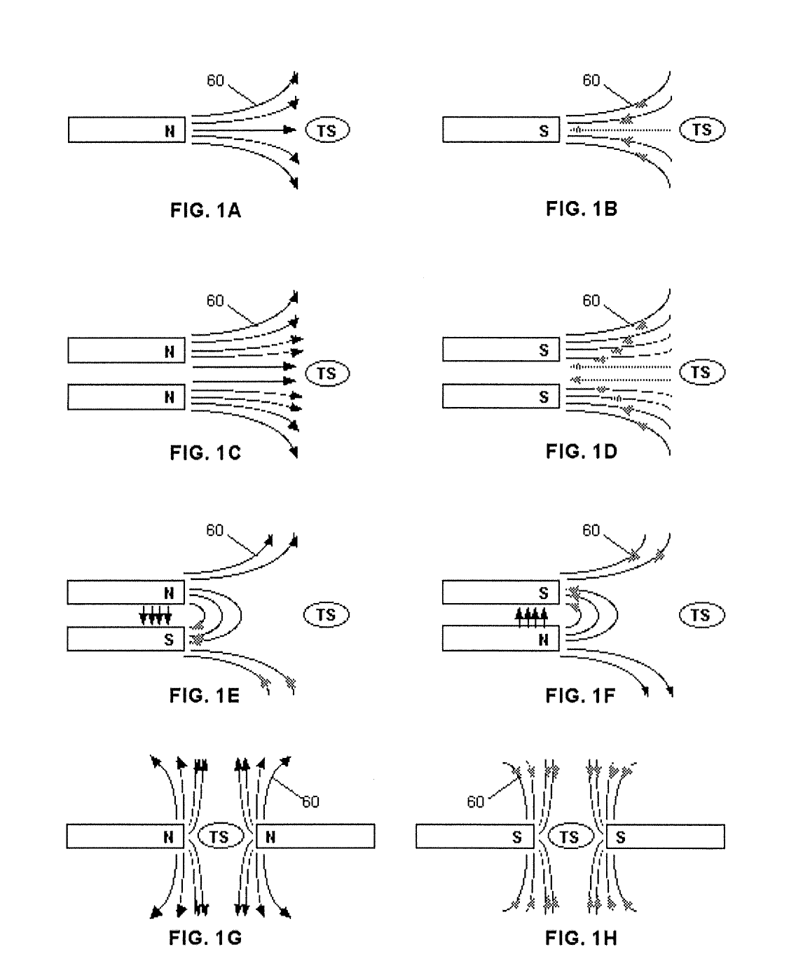

FIGS. 1A and 1B are schematic views of magnetic fluxes originating from a magnetic pole of a polarity N and S, respectively. It is appreciated that opposite poles are omitted in the above figures for simplicity. As shown in the figures, the magnetic fluxes 60 originate from the N pole and return to the S pole, while propagating the space. Thus, a certain amount of magnetic fluxes propagates through the space which is designated as “TS” or target space, where the amount depends upon a strength of the pole, a magnetic permeability of the space, a distance between the pole an the space, and the like. It is appreciated that magnetic fields formed around such magnetic poles can be easily obtained by constructing lines which are normal to such fluxes.

FIGS. 1C and 1D are schematic views of magnetic fluxes between and around two (or more) magnetic poles of the same polarity according to the present invention, where multiple magnetic poles are positioned on the same side of the “TS,” i.e., the target space. As shown in the figures, magnetic fluxes 60 from each pole propagate along the same direction and have the same phase angle (i.e., 0 in this case where the magnetic pole can be regarded as a source of a DC magnetic flux). Because two poles are disposed close to each other, the magnetic fluxes 60 from different poles propagate through the space relatively closer to each other than those of FIGS. 1A and 1B. Thus, more magnetic fluxes propagate into or out of the target space than the case of FIGS. 1A and 1B and, therefore, the intensity of the magnetic fields in the target spaces of FIGS. 1C and 1D. are greater than the intensity in those of FIGS. 1A and 1B.

FIGS. 1E and 1F are schematic views of magnetic fluxes between and around two (or more) magnetic poles of opposite polarities according to the present invention, where multiple magnetic poles are disposed on the same side of the target space. Due to their opposite polarities, each pole attracts the magnetic fluxes 60 of another pole. Because at least a portion of the magnetic fluxes 60 from the N pole directly returns to the S pole instead of propagating into the target space and then returning to the S pole, less magnetic fluxes 60 propagate into and out of the target space and the intensity of the magnetic field in the target spaces of FIGS. 1E and 1F is less than the intensity in those of FIGS. 1A and 1B, and much less than the intensity in those of FIGS. 1C and 1D.

FIGS. 1G and 1H are schematic views of magnetic fluxes between and around two (or more) magnetic poles of the same polarity according to the present invention, where multiple magnetic poles are positioned on opposite sides of the target space. Because of the same polarity, each pole tends to “oppose” or “repel” the magnetic fluxes 60 away therefrom, at least a portion of the magnetic fluxes 60 directly propagates away from the target space, instead of propagating into the target space and then returning to the S pole. Accordingly, less magnetic fluxes 60 propagate into and out of the target space and the intensity of the magnetic field in the target spaces of FIGS. 1G and 1H is less than the intensity in those of FIGS. 1A and 1B, and much less than the intensity in those of FIGS. 1C and 1D.

These figures illustrate that one can decrease an intensity of magnetic fluxes and/or magnetic fields in the target space by placing the magnets of opposite polarities on the same side of the target space or by disposing the magnets of the same polarity on the opposite sides of the target space. It is appreciated that the magnets of FIGS. 1A to 1H may be DC or AC, i.e., the magnets of FIGS. 1A to 1H may be permanent magnets in the case of DC or electromagnets operating on alternating currents in the case of AC. If the magnets are permanent magnets, they will generate the magnetic fields which are static in nature and the target space would be subject to static magnetic fields by definition. Thus, no electromagnetic waves would propagate through the target space. However, when the magnets are electromagnets operating on AC, they create electromagnetic fields which fluctuate in time, which are electromagnetic waves by definition. In this respect, one magnet shown in each of FIGS. 1E to 1H may be regarded as a “base unit” irradiating harmful electromagnetic waves or first electromagnetic waves, while another magnet in each of the same figures may be viewed as a “counter unit” emitting counter electromagnetic waves or second waves. Therefore, the mechanism explained through FIGS. 1A to 1H can lead to various EMC systems of the present invention which can “counter” the harmful electromagnetic waves inside the target space or which can decrease an intensity of electromagnetic waves in general inside the target space.

In another general aspect, a mechanism of such “countering” can be explained by resorting to basic theories of electromagnetism as well.

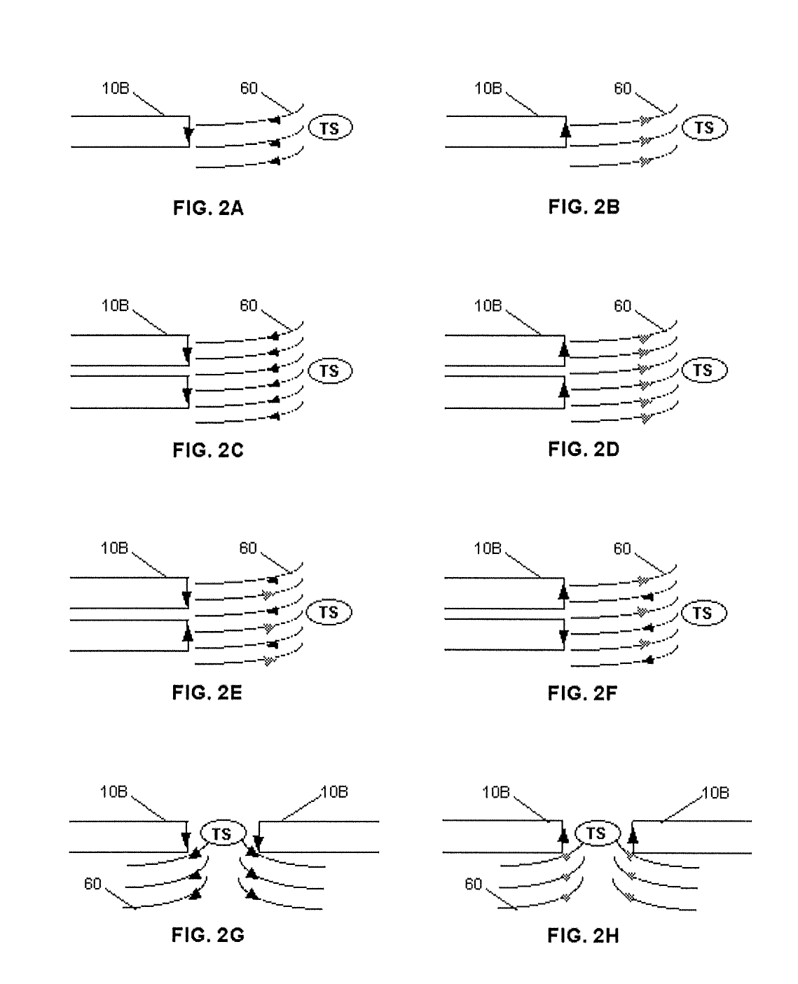

FIGS. 2A and 2B are schematic views of magnetic fluxes formed by electric current flowing in a single conductive path 10B. As described therein, electric current flowing in the direction of arrow forms magnetic fluxes 60, where the figures show only front quarters of such fluxes 60 for simplicity. Thus, a certain amount of magnetic fluxes 60 propagates through the target space, where the amount depends upon an amplitude of the current, a magnetic permeability of the space, a distance between the path an the space, and the like. It is appreciated that magnetic fields formed around such magnetic poles can be easily obtained by constructing lines which are normal to such fluxes.

FIGS. 2C and 2D are schematic views of magnetic fluxes between and around two (or more) conductive paths according to this invention, where multiple paths 10B are provided on the same side of the target space and where the currents flow in the same direction. Therefore, magnetic fluxes 60 originating from each path propagate in the same direction and through the space relatively closer to each other than those of FIGS. 2A and 2B. Thus, when the currents flowing in both conductive paths 10B have the same phase angle, more magnetic fluxes propagate into or out of the target space than the case of FIGS. 2A and 2B and the intensity of the magnetic fields in the target spaces of FIGS. 2C and 2D. are greater than the intensity in those of FIGS. 2A and 2B.

FIGS. 2E and 2F are schematic views of magnetic fluxes between and around two (or more) conductive paths according to the present invention, where the paths 10B are disposed on the same side of the target space and where the currents flow in opposite directions. Thus, magnetic fluxes 60 originating from each path propagate in opposite directions through the same space. Therefore, when the currents flowing in both paths 10B have the same phase angle, the magnetic fluxes 60 from each path 10B tend to cancel each other. As a result, less magnetic fluxes 60 propagate into and out of the target space and, therefore, the intensity of the magnetic fields in the target spaces of FIGS. 2E and 2F is less than the intensity in those of FIGS. 2A and 2B, and much less than the intensity in those of FIGS. 2C and 2D.

FIGS. 2G and 2H are schematic views of magnetic fluxes between and around two (or more) conductive paths according to this invention, where multiple paths 10B are provided on opposite sides of the target space and where the currents flow in the same direction. Because of the direction of the current as well as that of the magnetic fluxes 60 is identical, the magnetic fluxes 60 from each path 10B tend to suppress (i.e., oppose or repel) the fluxes 60 from another path from propagating into or toward the target space, i.e., the magnetic fluxes 60 from one path repel (i.e., oppose or suppress) those from another path. Accordingly, less magnetic fluxes 60 propagate into and out of the target space and the intensity of the magnetic fields in the target spaces of FIGS. 2G and 2H is less than the intensity in those of FIGS. 2A and 2B, and much less than the intensity in those of FIGS. 2C and 2D.

These figures illustrate that one can decrease an intensity of magnetic fluxes and/or magnetic fields in the target space by providing the conductive paths on the same side of the target space and then flowing the electric current therein in opposite directions or, alternatively, by disposing the paths on opposite sides of the target space and then flowing the electric current in the same direction. As described above, this generalization holds when the electric currents flowing in two or more of such conductive paths have the same phase angle. When the currents flowing in such paths have opposite phase angles such as, e.g., 180 degrees, then the reverse of the above generalization should hold. In addition, when the currents flowing in such paths have phase angles which are neither identical nor 180 degrees apart, then one should perform a vector operation in order to assess the net magnetic fields in the target space. Similarly, the above generalization holds when the conductive paths extend in the same direction. Therefore, one should perform the vector operation to assess the net magnetic fields when the conductive paths do not extend in the same direction.

It is appreciated that the currents flowing in each conductive path of FIGS. 2A to 2H may be DC or AC. If the currents are DC, they will generate the magnetic fields which are static in nature and the target space would be subject to static magnetic fields by definition. Accordingly, no electromagnetic waves would propagate through the target space. When the currents are AC, however they create electromagnetic fields which fluctuate in time, which are electromagnetic waves by definition. In this respect, one conductive path shown in each of FIGS. 2E to 2H may be viewed as a “base unit” which irradiates harmful electromagnetic waves or first electromagnetic waves, while another conductive path in each of the same figures may be viewed as a “counter unit” emitting counter electromagnetic waves or second waves. Accordingly, the mechanism explained through FIGS. 2A to 2H can lead to various EMC systems of this invention which can “counter” the harmful electromagnetic waves inside the target space or which can decrease the intensity of electromagnetic waves in general inside the target space.

The above concept of countering the harmful electromagnetic waves inside the target space or countering electromagnetic waves in general inside the target space is easy to apply in situations where sources of such waves have simple configurations, where electric currents flow in the wave sources defining conductive paths of simple geometries, and the like. However, electric and electronic devices generally incorporate various waves sources which have complex configurations and those devices also provide electric currents along the conductive paths of complicated geometries formed in multiple parts and multiple layers. Therefore, assessing various characteristics of the harmful waves and determining various characteristics of the counter waves which can effectively “counter” such harmful waves are not straightforward. To this end, various EMC systems of this invention resort to solve Maxwell's equations and other relevant equations in order to determine such characteristics of the counter waves and, when desirable, to assess various characteristics of the harmful waves.

Maxwell's equations are a set of four partial differential equations which describe how electric and magnetic fields relate to their sources, charge density, current density, and so on. Individually, the equations are known as “Gauss's law,” “Gauss's law for magnetism,” “Maxwell-Faraday equation” or “Faraday's law of induction”, and “Amperes' law” with Maxwell's correction. Often, two equations for the electromagnetic field tensor which give an equivalent relativistic formulation are typically called the Maxwell's equations as well. Maxwell's equations are generally provided in a differential form in terms of free charge and current, a differential form in terms of total charge and current, an integral form in terms of free charge and current, or an integral form in terms of total charge and current. Maxwell's equations are expressed in various bases, where following equations represent one version thereof. It is, therefore, appreciated that one can use Maxwell's equations in other versions which are readily available, e.g., in college physics textbooks.

First of all, following equations 1A to 1D represent Maxwell's equations in terms of free charge and current in a differential form:

### (1A) Gauss law:

QuickTime™ and a decompressor are needed to see this picture. [symbol] (Equation 1A)

(1B) Gauss law for magnetism:

QuickTime™ and a decompressor are needed to see this picture. [symbol] (Equation 1B)

(1C) Maxwell-Faraday equation or Faraday's law of induction:

QuickTime™ and a decompressor are needed to see this picture. [symbol] (Equation 1C)

(1D) Ampere's circuital law (with Maxwell's correction):

are needed to see this picture (Equation 1D)

where ‘D’ denotes the electric displacement field, is also called as the electric induction or electric flux density, and is measured in coulombs/square meter or, equivalently, Newtons per volt-meter in the SI unit, where [symbol] is the divergence operator, where [symbol] is the free charge density which generally does not include the bound charge and is measured in coulombs per cubic meter in the SI unit, where ‘B’ is the magnetic field, also called as the magnetic induction, the magnetic field density or the magnetic flux density, and measured in teslas or, equivalently, webers/square meter or volt-seconds/square meter in the SI unit, where ‘E’ is the electric field, also called as the electric field intensity, and then measured in volts/meter or, equivalently, Newtons/coulomb in the SI unit, where [symbol] is the curl operator, where [symbol] / [symbol] is the partial derivative with respect to time, where ‘H’ is the magnetizing field and, also called the auxiliary magnetic field, the magnetic field intensity or the magnetic field, and measured in ampere per meter in the SI unit, and where [symbol] is the free current density which does not generally include the bound current and is measured in amperes per square meter in the SI unit, and so on.

While the above Maxwell's equations 1A-1D describe how electric and magnetic fields relate to their sources, charge density, and/or current density in terms of free charge and current, another set of Maxwell's equations can be derived to depict such interaction of electric and magnetic fields in terms of total charge and current.

In contrary, following equations 2A to 2D are Maxwell's equations in terms of total charge and current in a differential form:

### (2A) Gauss law:

QuickTime™ and a decompressor are needed to see this picture. [symbol] (Equation 1A)

(2B) Gauss law for magnetism:

QuickTime™ and a decompressor are needed to see this picture. [symbol] (Equation 2B)

(2C) Maxwell-Faraday equation or Faraday's law of induction:

QuickTime™ and a decompressor are needed to see this picture. [symbol] (Equation 2C)

(2D) Ampere's circuital law (with Maxwell's correction):

QuickTime™ and a decompressor are needed to see this picture. [symbol] (Equation 2D)

where [symbol] is a universal constant which means the permittivity of free space and which is also called the electric constant and then measured in farads per meter in the SI unit, where [symbol] is the total charge density which does include both free and bound charge and is measured in coulombs per cubic meter in the SI unit, and where [symbol] is the total current density which does include both free and bound current and is measured in amperes per square meter in the SI unit.

It is appreciated that the above Maxwell's equations 1A to 1D and 2A to 2D are all derived in a differential form. That is, these equations are derived in an infinitesimal control volume To the contrary, Maxwell's equations can be derived in an integral form, i.e., based upon a finite control surface and/or control volume. Thus, Maxwell's equations can be derived in a integral form in terms of free charge and current as well as in terms of total charge and current. Following equations 3A to 3B described Maxwell's equations of the latter case in an integral form:

Maxwell's equations can also be presented in an integral form as well. For example, following equations 3A to 3D represent Maxwell's equations in terms of total charge and current in an integral form:

### (3A) Gauss law:

QuickTime™ and a decompressor are needed to see this picture. [symbol] (Equation 3A)

(3B) Gauss law for magnetism:

QuickTime™ and a decompressor are needed to see this picture. [symbol] (Equation 3B)

(3C) Maxwell-Faraday equation or Faraday's law of induction:

QuickTime™ and a decompressor are needed to see this picture. [symbol] (Equation 3C)

(3D) Ampere's circuital law (with Maxwell's correction):

QuickTime™ and a decompressor are needed to see this picture. [symbol] (Equation 3D)

where [symbol] means the differential vector element of surface area A, with infinitesimally small magnitude and is measured in square meters in the SI unit, where [symbol] means the net electric charge within the three-dimensional volume including both free and bound charge and is measured in coulombs in the SI unit, where [symbol] denotes the differential vector element of a path length tangential to the path or curve and is measured in meters in the SI unit, where [symbol] is the magnetic flux through a surface (which is not necessarily closed) and measured in webers or, equivalently, volt-seconds, where [symbol] is a universal constant denoting the permeability of free space, also called the magnetic constant, and measured in henries per meter or Newtons per ampere squared in the SI unit, where [symbol] is the electric flux through a surface (which is not necessarily closed) and measured in joule-meters per coulomb in the SI unit, where [symbol] denotes the net electrical current passing through a surface including both free and bound current and is measured in amperes, and where d/dt in equations 3C and 3D may be substituted by [symbol] / [symbol] which is the partial derivative with respect to time.

The above four equations, together with “Lorentz force law” constitute a complete set of laws of electromagnetism. Maxwell's equations are typically applied to macroscopic averages of the fields, which vary wildly on a microscopic scale in the vicinity of individual atoms where they are believed to undergo quantum mechanical effects as well. It is only in this averaged sense that quantities such as the permittivity and permeability of a material are estimated. At microscopic level, Maxwell's equations ignore quantum effects, and describe fields, charges and currents in a free space. But at this level of detail all charges, even those at an atomic level, must be accounted for correct answers. It is to be understood that the above Maxwell's equations along with Lorentz force law will be referred to as the “Equations” hereinafter.

As evident therefrom, obtaining analytical solutions of the Equations is not an easy task. First of all, it is impractical, if not impossible, to solve four partial differential equations simultaneously which are heavily related to each other. Secondly, most constitutive equations of the Equations are complex as well. Accordingly, analytically solving the E equations while substituting many complex constitutive equations thereto is almost impossible. In addition, these Equations require many initial and boundary conditions which are complex themselves.

Many numerical methods have been successfully developed to to obtain numerical solution of the Equations, examples of which include, but not limited to, the method of moments, finite difference time-domain method, and the like. In addition, these numerical methods have been expanded into many three-dimensional full-wave electromagnetic field simulation software packages which are available from various manufacturers. One is Mentor Graphics which is located on 8005 S.W. Boeckman Road, Wilsonville, Oreg. 97070, USA (503-685-7000 and www.mentor.com) and manufactures such software package under the trademark “IE3D.” Another is Ansoft which is located on 225 W. Station Square Dr, Suite 200, Pittsburgh, Pa. 15219, USA (412-261-3200 and www.ansoft.com) and manufactures such software package under the trademark “HFSS.” Another is Rencom which is located on 315 S. Allen Street, Suite 222, State College, Pa. 16801(814-861-1299 and www.rencom.com) and manufactures the software package under the trademark “XFDTD.” Yet another is CST AG which is located on Bad Nauheimer Str. 19, D-64289 Darmstadt, Germany (49-6151-7303-0 and www.cst.com) and which also manufactures the software under the trademark “CST”.

With the above Equations and various software packages in hand, one can assess radiative patterns of the harmful electromagnetic waves irradiated by the base unit. This can be done, e.g., by actually measuring such radiative patterns, by numerically solving the Equations subject to various characteristics of the base unit and operating conditions thereof, and the like. Of course, one can also obtain electromagnetic fields or fluxes associated with the radiative patterns. Based on these fluxes, fields, and radiative patterns, one can then assess radiative patterns, fluxes or fields of the counter electromagnetic waves which “counter” the harmful waves in the target space qualitatively (or by a preset extent, e.g., by 70%, 90%, and the like) or quantitatively (or below a preset limit, e.g., below 25 mG, 2.5 mG, and the like). Thereafter, one can analytically calculate or resort to the above software packages to determine various characteristics and operating conditions of the counter unit to emit such counter waves.

Although these commercial software package provide the numerical solution of the Equations, situations may arise when one can attempt to solve those Equations analytically by simplifying at least one term of one of such Equations or by simplifying at least one of the Equations. Examples of these situation may include when one of the First or Second Characteristics allows cancelation of one term of the Equations, when two or more terms of the Equations cancel each other, when one term of the Equations may depend upon another term of the same of different one of such Equations, and the like. Another situation is when at least one term of the Equations or at least one of the Equations becomes relatively unimportant (or small) than the rest. In this case, such term or equation can be approximated in such a way that one can analytically obtain a solution of the Equations or that one can simplify the Equations and obtain a numerical solution of the Equations faster or more efficiently. When desirable, one can analytically solve at least one of the Equations or analytically rearrange the Equations and then obtain the numerical solution of the resulting Equations. Other methods may also be employed as long as such methods facilitate obtaining the analytic or numerical solution of the Equations. Therefore, the “solution” means any solutions obtained by any methods described in this disclosure, where such methods shall include the above simplification and approximation as well as other simplifications and approximations provided in various textbooks in college physics, electromagnetism, electromagnetic wave theories, antenna theories, and the like.

Followings illustrate other general aspects of the present invention which serve to explain the above principles and their application to various systems and methods in which various counter units “counter” the harmful electromagnetic waves in the target space by a preset extent or to maintain an intensity of the harmful waves below a preset limit or in which various counter units “counters” such harmful waves and decreases the intensity of any electromagnetic waves in specific frequencies in the target space by a preset extent or below the preset limit. Although the principles and applications of various systems and methods of this invention are illustrated in the following general aspects by resorting to a personal communication system and an areal communication system, it is appreciated that such principles and applications of this invention apply to other electric or electronic systems or devices described herein for countering the harmful or first electromagnetic waves with the counter or second electromagnetic waves.

In another general aspect, an EMC system is provided as a personal communication system which is provided for a specific purpose of unilateral, bilateral or multilateral wireless communication. It is appreciated that such personal communication EMC system can perform other functions such as, e.g., acquiring various analog or digital data, processing such data, and the like.

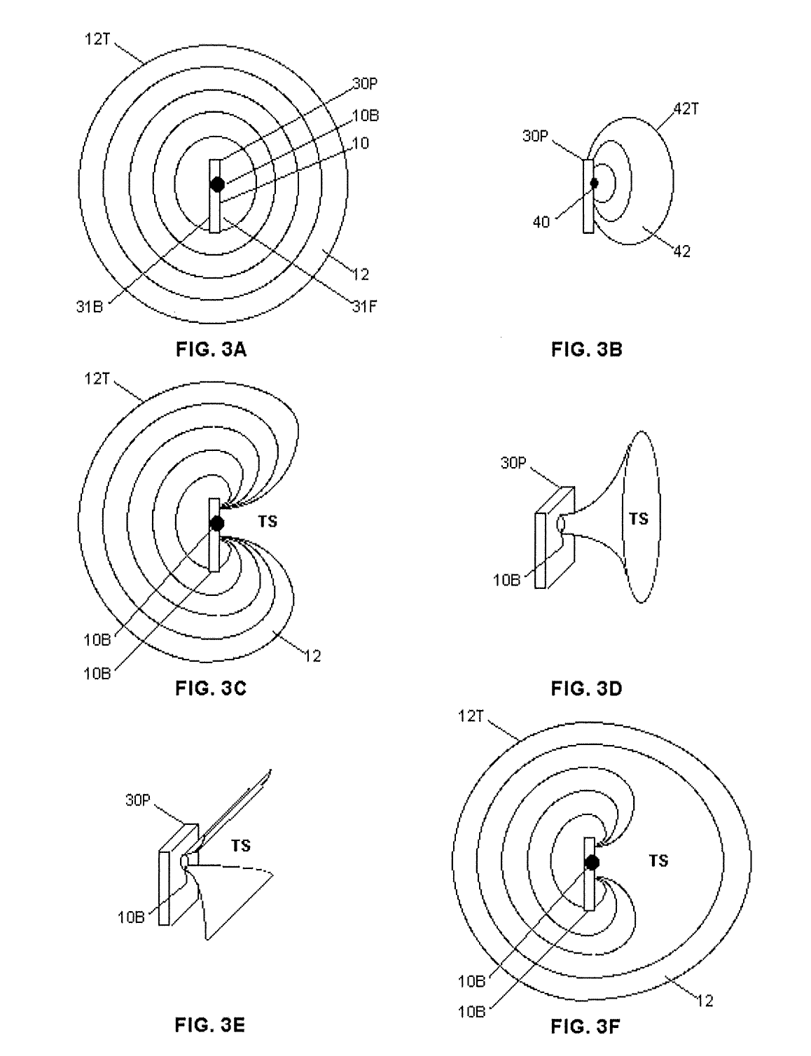

FIG. 3A is a schematic view of a conventional personal communication device 20P including at least one wave source (will also be referred to as the “transmitting module” or “antenna” hereinafter) 10 irradiating harmful electromagnetic waves (will be referred to as the “first electromagnetic waves” hereinafter as well) 12 to serve a specific purpose of wireless communication. The wave source 10 includes at least one base unit 10B which refers to only portions of the wave source (or transmitting module, antenna) 10 responsible for irradiating the harmful (or first) waves 12 or affecting paths of propagation of the harmful (or first) waves 12. The device 20P also includes a case with a front side or front 31F and a back side or back 31B.

In operation, the base unit 10B irradiates the harmful waves 12 which propagate therearound in 360 degrees while defining preset wavefronts (will also be referred to as “electromagnetic fields” hereinafter) 12T. Accordingly, the harmful waves 12 form a space in which an intensity of magnetic waves thereof exceeds a certain value, where such a space is to be referred to as an “active space” hereinafter. Detailed characteristics of the harmful waves 12, those of their wavefronts 12T, and those of the active space depend on many factors related to detailed configurations of the base unit 10B as well as operational conditions of the base unit 10B. Examples of such factors include, but not be limited to, a first composition of matter of the base unit 10B, a first configuration thereof, a first arrangement and a first disposition thereof, a first path of first electric current defined in the base unit 10B, a first dynamic property of the first electric current flowing in such a first path, and other factors known in the art which affect irradiation of the harmful waves 12 or the propagation paths thereof. All of such factors are to be referred to as “the First Characteristics” hereinafter.

As a user uses the device 20P, he or she positions the front 31F of the device 20P close to his or her ear, and the harmful waves 12 travelling away from the base unit 10B propagate into a target space which is depicted as “TS’ in the figure and which may be defined, e.g., around an ear or a brain of the user for the personal communication device. As a result, at least a substantial or entire portion of the target space may fall in the active space, i.e., the ear or brain of the user falls within the active space and, therefore, are susceptible to those harmful waves.

FIG. 3B is a schematic view of an exemplary embodiment of an EMC personal communication system 30P which includes at least one counter unit 40 emitting counter electromagnetic waves (will be referred to as the “second electromagnetic waves” as well hereinafter) 42 for countering at least a portion of the harmful waves. To this end, the counter unit 40 is configured and operated according to at least one solution of the Equations so that the counter waves 42 emitted by the counter unit 40 are capable of countering the harmful waves 12 in a target space (denoted as “TS”) by a preset extent or below a preset limit.

In operation, the counter unit 40 is configured to emit the counter waves 42 therearound but to preferably direct such waves 42 into a preset direction. In the embodiment depicted in this figure, the counter unit 42 is configured to direct the counter waves 42 preferentially along a forward direction, while preventing the counter waves 42 from propagating backward. Accordingly, the counter waves 42 emitted by the counter unit 40 of this embodiment tend to define wavefronts (will also be referred to as “electromagnetic fields” hereinafter) as exemplified in the figure. In addition, the counter waves 42 form a space in which an intensity of magnetic waves thereof exceeds a certain value, similar to the active space defined by the harmful waves. Detailed characteristics of such counter waves 42, those of their wavefronts 42T, and those of the active space of the counter waves depend on many factors which are related to detailed configurations of the counter unit 40 and operational conditions thereof. Examples of such factors may include, but not limited to, a second composition of matter of the counter unit 40, a second configuration thereof, a second arrangement or disposition thereof with respect to the base unit 10B, a second path of second electric current defined in the counter unit 40, a second dynamic property of the second electric current which flows in the second path, and other factors known in the art which affect irradiation of the counter waves 12 or their propagation paths. All of such factors are to be referred to as “the Second Characteristics” hereinafter.

FIG. 3C is a schematic view of an exemplary embodiment of an EMC personal communication system 30P which includes the base unit 10B of FIG. 3A irradiating the harmful waves 12 as well as the counter unit 40 of FIG. 3B emitting the counter waves 42 according to the present invention. As shown in the figure, the counter unit 40 is disposed in a preset relation to the base unit 10B and also configured to emit the counter waves 42 which counter the harmful waves 12 in a preset space by, e.g., canceling at least a portion of the harmful waves 12 therein or suppressing (to be referred to as “opposing” or “repelling” as well hereinafter) the harmful waves 12 from propagating into the preset space. As a result, the counter unit 40 can form a space (i.e., a “target space”) in which an intensity of the harmful waves is decreased by a preset extent or below a preset limit or in which an intensity of all electromagnetic waves of certain frequencies is decreased by the preset extent or below the preset limit. At the same time, the active space in which the intensity of the harmful waves 12 or the magnetic waves thereof 12 exceeds a certain limit also shrinks in its size as manifest herein.

As described above, effective countering of the harmful waves 12 by the counter waves 42 can be ensured by first assessing the First Characteristics of the base unit 10B and harmful waves 12, by analytically or numerically obtaining at least one of the Second Characteristics of the counter unit 40 and counter waves 42 capable of countering the harmful waves 12 inside the target space, and then by analytically or numerically obtaining at least one solution of the Equations which satisfies the First and/or Second Characteristics, which is then used to design the counter unit 40 which can emit such counter waves 42. It is appreciated that the above method generally applies to a situation in which the system 30P is first constructed with the wave source 10 and base unit 10B and in which the counter unit 40 is designed based on the First Characteristics and solution of the Equations and then incorporated thereinto in retrospect. Alternatively, the base unit 10B and counter unit 40 can also be designed and then incorporated into the system 30P rather simultaneously. Because the base and counter units 10B, 40 can be designed while considering the Characteristics of another, this method may help constructing such units 10B, 40 readily and economically. It is appreciated that the method of designing the counter unit 40 based on the First Characteristics and another method of designing the counter unit 40 along with the base unit 10B apply to all EMC systems of this invention described heretofore and to be described hereinafter.

It is appreciated that the Second characteristics of the counter unit 40 and counter waves 42 depend upon detailed mode of the “countering” as well. For example, the second configuration of the counter unit 40, its second disposition with respect to the base unit 10B, an amplitude of the second electric current as well as its phase angle, and other Second Characteristics should be manipulated in such a way that the counter waves 42 can cancel the harmful waves 12 in the target space when the “countering” is to be preferentially accomplished by the canceling. Because the base unit 10B and counter unit 40 are disposed on the same side of the target space, this means that the counter waves 40 preferably define the second phase angle which is at least partially opposite to that of the harmful waves 42, as illustrated in conjunction with FIGS. 1E, 1F, 2E, and 2F. However, it is appreciated that the counter waves 40 may define the phase angle which is at least partially in phase with that of the harmful waves 12 for such canceling when other Second Characteristics are altered. That is, when the first and second paths are defined in the same direction but when the first and second currents flow in opposite directions, the counter waves 42 define the phase angle which is at least partially in phase with that of the harmful waves 42 for canceling the harmful waves 12 with the counter waves 40. In another example, the second configuration of the counter unit 40, its second disposition relative to the base unit 10B, an amplitude of the second electric current as well as its phase angle, and other Second Characteristics may be manipulated in such a way that the counter waves 42 can oppose or repel the harmful waves 12 from propagating toward or into the target space when such “countering” is to be preferentially accomplished by the suppressing. Because the base unit 10B and counter unit 40 are disposed on the same side of the target space, this implies that the counter waves 40 define the second phase angle which is at least partially in phase with that of the harmful waves 42, as also illustrated in conjunction with FIGS. 1G, 1H, 2G, and 2H. It is also appreciated that the counter waves 40 may define the phase angle which is at least partially opposite to that of the harmful waves 12 for such suppressing when other Second Characteristics are altered. That is, when the first and second paths are defined in the same direction but the first and second currents flow in opposite directions, the counter waves 42 define the phase angle which is at least partially opposite to that of the harmful waves 42 for such suppressing. In short, various embodiments of the EMC system described in this paragraph indicate that, based on the First Characteristics and the solution of the Equations, one can construct a variety of counter units 40 which can counter the harmful waves 12 either by canceling, suppressing or both. It is appreciated that the method of designing the counter unit 40 which counters the harmful waves 12 preferentially by canceling and another method of designing the counter unit 40 which counters the harmful waves 12 preferentially by suppressing apply to all EMC systems of this invention described heretofore and to be described hereinafter.

FIGS. 3D, 3E, and 3F are schematic views of exemplary embodiments of various target spaces formed around the personal communication systems by various counter units of the present invention. The counter unit 40 of FIG. 3D is configured to emit the counter waves 42 with the wavefronts which define a shape of a cone or a truncated cone, have an apex near the front side 31F of the system 30P, and then expand toward or into the target space. Therefore, the counter waves 42 can counter the harmful waves preferentially in the target space defined near the front side 31F of the system 30P while encroaching into the active space of the harmful waves 12 and enclosing an ear or a brain of a user of the system 30P. In contrary, the counter unit 40 of FIG. 3E is configured to emit the counter waves 42 with the wavefronts which define a shape of a three-dimensional wedge, start at or near the front side 31F of the system 30P, and then expands toward or into the target space. Accordingly, the counter waves 42 counter the harmful waves preferentially near the front side 31F of the system 30P while enclosing an ear or a brain of user of the system 30P. It is appreciated that the target space of FIG. 3E is similar to that of FIG. 3D in that both target spaces are open in nature and are not bound at all in at least one direction. However, the target space of FIG. 3E differs from that of FIG. 3D in that the target space of FIG. 3E expands in one direction while dissecting or separating the active space of the harmful waves 12 into two or more smaller active spaces but that the target space of FIG. 3D encroaches into a certain portion of the active space while rendering the rest of the active space as one space. Contrary to that of FIGS. 3D and 3E, the counter unit 40 of FIG. 3F is configured to emit the counter waves 42 defining the wavefronts which have a shape of a sphere or an eccentric sphere, have an apex near the front side 31F of the system 30P, and then similarly expand toward or into the target space. Accordingly, the counter waves 42 can counter the harmful waves preferentially in the closed target space defined near the front side 31F of the system 30P, while carving out a spherical portion of the active space of the harmful waves 12 and enclosing an ear or a brain of a user of the system 30P.

As described above, effective formation of the target space by the counter waves 42 can be ensured by first assessing the First Characteristics of the base unit 10B and harmful waves 12, by assessing the Second Characteristics of the counter unit 40 and counter waves 42, by analytically or numerically obtaining at least one solution of the Equations which can satisfy the First and/or Second Characteristics, and so on. The solution is then used to obtain a distribution pattern of electromagnetic fluxes or magnetic fluxes near or around the base and counter units 10B, 40 and to assess an exact location, a shape, and/or a size of the target space in which the intensity of the harmful waves 12 is decreased by the preset amount or below the preset limit or in which the intensity of electromagnetic waves of preset frequencies is decreased by the preset amount or below the preset limit. Therefore, this implies that one can manipulate an exact configuration, location, and other characteristics of the target space by way of varying one or more of the Second Characteristics and/or one or more of the First Characteristics.

In one example, one can utilize the solution of the Equations in such a way of constructing the counter unit 40 and operating such a unit 40 to emit the counter waves 42 which form an open target space, such as those exemplified in FIGS. 3D and 3E. It is appreciated that the system 30P may not be able to serve its preset purpose or may only be able to minimally serve its purpose in the target space, for the intensity of the harmful waves 12 is to be maintained below the preset limit. Accordingly, when the counter unit 40 forms a target space which is open in at least one direction (La, not bound in that direction), the system 30P may find it difficult to serve its intended purpose in a direction in which the open target space expands. In contrary, the counter unit 40 may instead emit the counter waves 42 which form a closed target space, such as the one described in FIG. 3F. Accordingly, it is preferable for the counter unit 40 of such a personal communication device to define a closed target space than an open one, for the closed target space does not hinder the user of the system 30P from wirelessly communicating with others in any direction outside the target space, whereas the open target space prevents the user from communicating in the direction along which the open target space extends.

In another example, one can utilize the solution of the Equations in such a way of constructing the counter unit 40 and operating such a unit 40 to emit the counter waves 42 which define the target space in various zones near or around the base unit 10B or counter unit 40. For example, the counter unit 40 may define a first zone of the target space which is two-dimensional and is defined in a preset relation to the counter unit 40. The counter unit 40 may also define a second zone of the target space which is three-dimensional and defined in a preset relation to the counter unit 40. The counter unit 40 may define a third zone of the target space defined around or about at least a portion of the base or counter unit 10B, 40. The counter unit 40 may define a fourth zone of the target space defined along at least a portion of the base or counter unit 10B, 40. The counter unit 40 may form a fifth zone of the target space which is defined around or about at least one side of the base or counter unit 10B, 40. The counter unit 40 may define a sixth zone of the target space defined lateral to or side by side with at least a portion of the base or counter unit 10B, 40. The counter unit 40 may define a seventh zone of the target space defined angularly about at least a portion of the base or counter unit 10B, 40. The counter unit 40 may instead form an eighth zone of the target space defined on, over or above at least a portion of the base or counter unit 10B, 40. The counter unit 40 may define a ninth zone of the target space in an elevation similar to at least a portion of the base or counter unit 10B, 40. The counter unit 40 may define a tenth zone of the target space defined below or under at least a portion of the base or counter unit 10B, 40.

In another example, one can utilize the solution of the Equations in such a way of constructing the counter unit 40 and operating such a unit 40 to emit the counter waves 42 which define the target space encompassing various sizes or volumes. As described hereinabove, the target space may be shaped or sized to enclose therein only one or a few organs of the body (e.g., a typical target space for a sound generating device or other devices), an entire human body (e.g., a typical target space for a personal communication device or other devices), a few or even tens, hundreds or thousands of human bodies (e.g., a typical target space for a areal communication device or other devices), and the like. Accordingly, the target space may have a first size which is about as large as the active space formed by the harmful waves 12, a second size which is smaller than the active space, a third size corresponding to a size of at least one corner of the active space, a fourth size corresponding to a size of about at least one strip defined across or along at least a portion of the active space, a fifth size voluminous enough to enclose therein a preset local geographic area, a sixth size voluminous enough to enclose at least two people therein, a seventh size which is smaller than the sixth size but voluminous enough to enclose therein a single user of the system, an eighth size voluminous enough to enclose therein at least a substantial portion of a body of the user, a ninth size voluminous enough to enclose therein about one half of the body of the user, a tenth size voluminous enough to enclose therein a head of the user, an eleventh size voluminous enough to enclose therein a brain of the user, and the like.

In another example, one can use the solution of the Equations in such a way of constructing the counter unit 40 and operating the unit 40 to emit the counter waves 42 capable of forming a target space which forms a preset shape which is characterized by its cross-section which may be a two-dimensional shape such as, e.g., a triangle, a square, a diamond, a rectangle, a trapezoid, a polygon having at least five sides, a polygon with at least one curved side, a circle, an annulus, a crescent, an ellipse, an oval, a shape with at least one parabolic side, a shape with at least one hyperbolic side, a shape with an arcuate side, a lemniscate, an astroid, a lune, a deltoid, a fraction or a truncation of any of the above, any of the above shapes with at least one rounded corner, and a combination of any of the above. Based on these cross-sectional shapes, one can then use the solution of the Equations in such a way of constructing the counter unit 40 and operating the unit 40 to emit the counter waves 42 capable of forming a target space which forms a preset three-dimensional shape or volume such as, e.g., a sphere, a hemisphere, a cone, a cube, a polyhedron, an ellipsoid, any three-dimensional volume obtained by translating, rotating, and/or revolving at least one of the above two-dimensional shapes, a truncation of any of the above, a fraction of any of the above, and a combination of any of the above.

In another example, one can use the solution of the Equations in such a way of constructing the counter unit 40 and operating such a unit 40 to emit the counter waves 42 capable of forming the target space in a variety of dispositions. In the first exemplary disposition, the target space is entirely enclosed within the active space, while the target space is partially enclosed by the active space and open through a single portion a border or a boundary of the active space to an exterior of the active space in the second disposition. In the third disposition, the target space traverses through the active space while forming a conduit therethrough, and the target space traverses through the active space and divides or separates the active space into at least two separate smaller active spaces in another disposition.

In another example, one can use the solution of the Equations in such a way of disposing the counter unit 40 and operating the counter unit 40 to emit the counter waves 42 capable of forming the target space having a desirable configuration in a desirable location with respect to the base unit 10B. In one example, the counter unit is disposed between the target space and base unit 10B, where an amplitude of the counter waves 42 is less than those of the harmful waves 12. In another example, the counter unit 42 is disposed on an opposite side of the target space with respect to the base unit 10B, where an amplitude of the counter waves 42 is enough to perform the “countering” by the preset extent or below the preset limit. In another example, the counter unit 42 is disposed at a first distance from a center of the target space, where the first distance is neither substantially greater nor substantially less than a second distance between the base unit 10B and center of the target space and where an amplitude of the counter waves 42 is enough to perform the “countering” by the preset extent or below the preset limit. In another example, the counter unit 40 is disposed at a third distance from the center, where the third distance is substantially greater or substantially less than the second distance and where an amplitude of the counter waves 42 is enough to perform the “countering” by the preset extent or below the preset limit.

It is appreciated that one can use the solution of such Equations in any of the above examples in a reverse manner. That is, once the Second Characteristics are given as a preset condition for the system 30P, one can use the solution of the Equations to determine the target space which is formed by such Second Characteristics. In such a situation, one may try to manipulate at least one of the First Characteristics for the proper “countering,” i.e., decreasing the intensity of the harmful waves (or all electromagnetic waves) inside the target space by the preset extent or below the preset limit.

In another general aspect, an EMC system is formed as an areal communication system which is constructed for a specific purpose of broadcasting signals (e.g., electromagnetic waves of preset frequencies) for wireless communication, wireless broadcast, and the like. It is appreciated that such areal communication EMC system can perform other functions such as, e.g., acquiring various analog or digital data or processing such data.

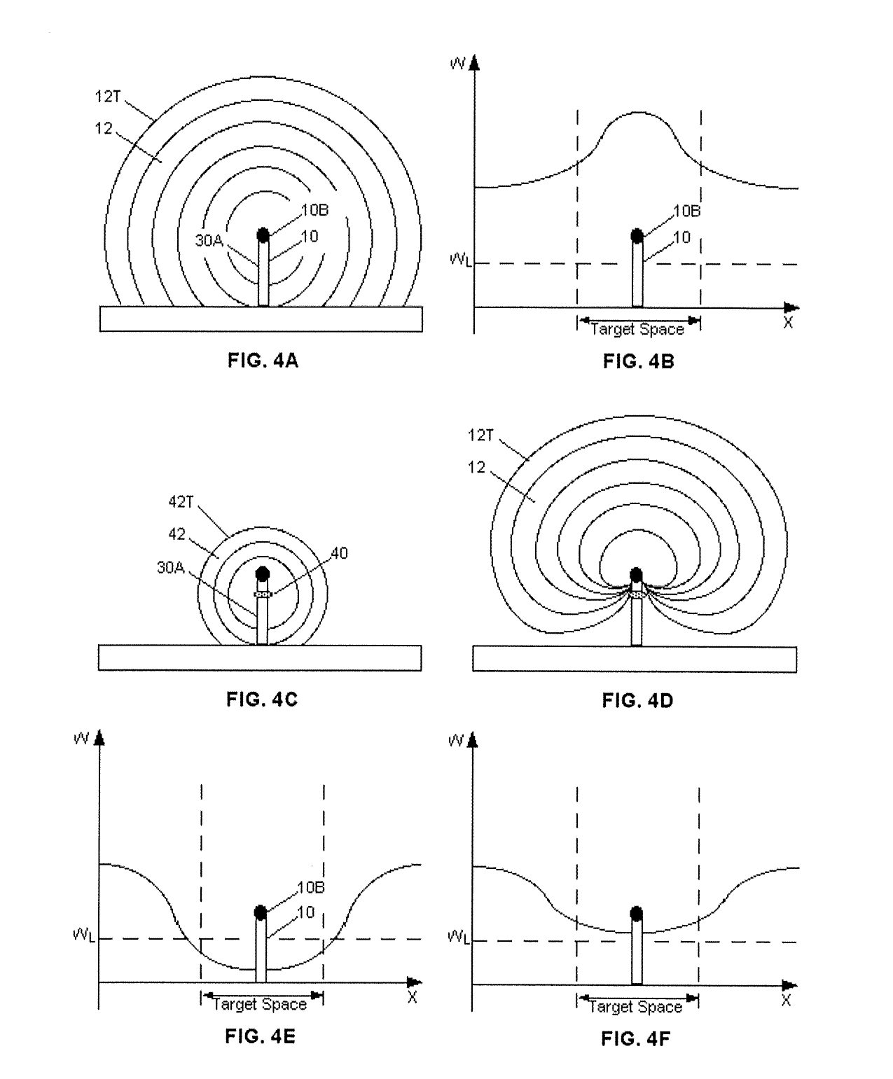

FIG. 4A is a schematic view of a conventional areal communication device 20A which includes at least one wave source (interchangeably referred to as a “transmitting module” or “antenna”) 10 for irradiating harmful electromagnetic waves (interchangeably referred to as the “first waves”) 12 so as to serve the specific purpose of broadcasting or transmitting electromagnetic waves for the wireless communication or broadcast. The wave source 10 includes at least one base unit 10B which refers to only portions of the wave source 10 responsible for irradiating the harmful waves 12 and/or affecting propagation paths of the harmful waves 12. In order to maximize a broadcasting efficiency, the wave source 10 of the areal communication device 20A is preferably disposed on top of a tall structure such as a tower, a pole or a mast.

In operation, the base unit 10B irradiates the harmful waves 12 which form preset wavefronts (interchangeably referred to as “electromagnetic fields”) 12T. Accordingly, the harmful waves 12 form an active space in which an intensity of the harmful waves, all electromagnetic waves defining preset frequencies or their magnetic waves exceeds a certain value, where detailed characteristics of such harmful waves 12, those of their wavefronts 12T, and those of the active space depend upon at least one of the First Characteristics. For example, FIG. 4B shows an active space in which the intensity of such waves (denoted as “W” along the ordinate) is to exceed a certain limit (denoted as “W_{L}” along a distance which is denoted along the abscissa.

In contrary to the case of the personal communication device of FIG. 3A in which a user may avoid the harmful waves by choosing to not use such a device 20P, the areal communication device 20A in FIGS. 4A and 4B irradiates the harmful waves to any person who happens to be inside such an active area. As a result, an entire body of the person may be affected by those harmful waves.

FIG. 4C shows a schematic view of an exemplary embodiment of an EMC areal communication system 30A which includes at least one counter unit 40 which emits counter electromagnetic waves (interchangeably referred to as the “second electromagnetic waves” or simply “second waves”) 42 for countering at least a portion of the harmful waves. To this end, the counter unit 40 is configured and operated according to at least one solution of the Equations in such a way that the counter waves 42 emitted by the counter unit 40 are capable of countering the harmful waves 12 in a target space by a preset extent or below a preset limit.

In operation, the counter unit 40 is configured to emit the counter waves 42 therearound but to preferably direct the counter waves 42 into a preset direction. In this embodiment, the counter unit 42 is preferentially configured to direct the counter waves 42 downwardly, while preventing the counter waves 42 from propagating upward. Accordingly, the counter waves 42 emitted by the counter unit 40 of this embodiment define the wavefronts as shown in the figure. In addition, the counter waves 42 form a space in which an intensity of magnetic waves thereof exceeds a certain value, similar to the active space defined by the harmful waves, where detailed characteristics of the counter waves 42, those of their wavefronts 42T, and those of the active space of the counter waves depend upon at least one of the Second Characteristics

FIG. 4D shows a schematic view of an exemplary embodiment of an EMC areal communication system 30A which includes the base unit 10B of FIG. 4A irradiating the harmful waves 12 as well as the counter unit 40 of FIG. 4C emitting such counter waves 42 according to the present invention. The counter unit 40 is disposed in a preset relation to the base unit 10B and configured to emit the counter waves 42 capable of countering the harmful waves 12 inside the target space by canceling at least a portion of the harmful waves 12 and/or suppressing, opposing or repelling at least a portion of such harmful waves 12. As a result and as depicted in FIG. 4E, the counter unit 40 defines the target space in which the intensity of the harmful waves is decreased by a preset extent or below a preset limit as denoted by W_{L}. At the same time, the active space in which the intensity of the harmful waves 12 or the magnetic waves thereof 12 exceeds W_{L} shrinks in its size as manifest herein.

It is appreciated that the EMC areal communication system 30P in FIG. 4E may find it difficult to serve its purpose in the target space, because the intensity of the harmful waves is below W_{L} and, as a result, no communication devices in that space may not be able to pick up the harmful waves. As an alternative and as exemplified in FIG. 4F, the counter unit 40 is configured to emit the counter waves 42 countering the harmful waves 12 inside the target space by a preset extent such that the intensity of the harmful waves are decreased but slightly above the preset limit, W_{L}, so that the communication devices may send and receive the harmful waves and serve the communication purpose while also minimizing the potential health hazards to the users. Although not illustrated in the figure, the counter unit 40 may be configured to emit the counter waves 42 so that the intensity of the harmful waves 12 inside the target space may become less than the limit but define various distributions. For example, the intensity may be greatest near a boundary or border of the target space. In another example, the intensity may be at least partly uniform in a substantial portion of the target space or may be lowest near the counter unit 40. In another example, the intensity may be the lowest between at least two of multiple counter units 40.

Effective countering of the harmful waves 12 by the counter waves 42 emitted from the areal communication system 30A can be ensured by similar methods as have been described in conjunction with the personal communication system 30P. The Second characteristics of the counter unit 40 and counter waves 42 of the areal communication system 30A also depend upon the detailed mode of the “countering” as has been the case with the personal communication system 30P.

The counter unit 40 of the areal communication system 30A can form the target space which may define an open space or closed space, may define a funnel-like target space or a wedge-shaped target space, similar to those of the personal communication system 30P. Effective formation of such a target space by the areal communication system 30A may be ensured by similar methods as have been provided in conjunction with the personal communication system 30P, e.g., by defining the target space in various zones near or around the base or counter unit 10B, 40, by forming the target space in various sizes or volumes, by forming the target space with various cross-sections or volumes, by providing the target space in various dispositions, and the like. Other configurational and/or operational characteristics of those counter units exemplified in the EMC personal communication system of FIGS. 3B to 3F also apply to the EMC areal communication system of FIGS. 4C to 4F and other EMC systems to be disclosed hereinafter.

Those base units of the personal or areal communication systems or their antennas typically refer to conventional antennas such as, e.g., electrically small antennas, resonant antennas (such as, e.g., a straight wire dipole antenna, vee dipole antenna, folded dipole antenna, Yagi-Uda antenna, corner reflector antenna, loop antenna, microstrip antenna, and the like), broadband antennas (such as, e.g., a traveling-wave wire antenna, traveling-wave vee antenna, Beverage antenna, biconical antenna, discone antenna, wave antenna, rhombic antenna, helix or helical antenna, sleeve antenna, frequency-independent antenna, spiral antenna, sinuous antenna, bow-tie antenna, wedge antenna, bifin antenna, log-periodic antenna, trapezoid antenna or wire antenna), aperture antennas (such as, e.g., a rectangular aperture antenna (including a tapered or horn aperture antenna, a circular aperture antenna, and the like), tapered antenna, reflector antenna, parabolic reflector antenna, dual reflector antenna, offset parabolic antenna or field antenna), and the like. Such antennas may include a mono-pole antenna, dipole antenna (such as, e.g., a straight wire dipole antenna, vee dipole antenna, folded dipole antenna, and the like), small loop antenna, large loop antenna, arrays of such antennas (such as, e.g., a phased array, linear array, endfire array, planar array, conformal array or multidimensional array), and the like.

When the EMC system of the present invention relates to various EMC personal communication systems, areal communication systems, and/or power transmission systems, the First Characteristics of the base units of such systems as well as the Second Characteristics of the counter units thereof may include other parameters related to antenna performance in general. Accordingly, such First and Second Characteristics may also include, but not limited to, a radiation pattern (such as, e.g., angular variation of radiation around the antenna such as a directive antenna (irradiating a single or multiple narrow beams) or omnidirectional antenna in broadcast situations), a directivity (such as, e.g., a ratio of power density in a direction of the radiation pattern maximum to an average power density at the same distance from the antenna), gain (such as, e.g., a directivity reduced by losses of the antenna), polarization (such as, e.g., a vector nature of electric fields radiated by an antenna, a figure traced out with time by an instantaneous electric field vector associated with the radiation from an antenna when transmitting linear, circular or elliptical waves), an impedance (such as, e.g., an input impedance at an antenna terminal), a bandwidth (such as, e.g., a range of frequencies over which at least one important performance parameter is acceptable), scanning (such as e.g. a movement of the radiation pattern in space, accomplished by mechanical movement or by electronic means such as adjustment of antenna current phase), and other system considerations such as, e.g., its size, weight, power handling, radar cross section, environmental operating conditions, and the like.

One may also refer to further theoretical or operational details of such antennas as provided in many books in the relevant art in order to construct and operate such counter units of this invention. The first is “Antenna Theory: Analysis and Design (3rd ed.)” by Constantine A. Balanis, published by John Wiley & Sons, Inc. (ISBN 0-471-66782-X). The second is “Antenna Theory and Design (2nd ed.)” by Warren L. Stutzman and Gary A. Thiele, published by John Wiley & Sons, Inc. (ISBN 0-471-02590-9). The third is “Practical Antenna Handbook (4th ed.)” by Joseph J. Carr, published by McGraw-Hill (ISBN 0-07-137435-3). The fourth is “The ARRL Antenna Book (19th ed.)” which is edited by R. Dean Straw and published by ARRL (ISBN 0-87259-804-7). The fifth is “Antennas for All Applications” by John D. Kraus and Ronald J. Marhefka, published by McGraw-Hill (ISBN 0-07-123201-X).

Although not shown in the figure, such principles of and their application to the EMC personal and areal communication systems 30P, 30A also apply to an EMC power transmission system which is designed to wirelessly deliver energy by irradiating electromagnetic waves which carry therealong electromagnetic energy or power for the preset purpose of wireless power transmission. In general, an EMC power transmission system includes at least one wave source which in turn includes at least one base unit which serves as a transmitting module for such harmful waves and which is identical or at least similar to that of the EMC personal and areal communication systems 30P, 30A. The system also includes at least one counter unit which is identical or at least similar to that of the EMC personal and areal communication systems 30P, 30A and which emits the counter waves which are identical or at least similar to those emitted by their counterparts of the EMC personal and areal communication systems 30P, 30A. The only exceptions would be that the counter waves of the power transmission system may define different frequencies, have different amplitudes, form the target spaces defining different shapes and sizes and created in different dispositions, and the like.

Unlike the areal communication system where the harmful waves have amplitudes enough to perform wireless communication within a certain distance, the typical power transmission system is configured to deliver energy via electromagnetic waves of higher amplitudes. Therefore, it is typically preferable that the target space be defined in those places where users do not reside or only during a short period. As a result, the counter unit of the areal transmission system is configured to define the active spaces in multiple portions of the building, house or room which warrant frequent contact with persons, whereas the counter waves of the power transmission system define the target spaces in multiple portions of the building, house or room which warrants least contact with users to allow the power transmission. Thus, the counter unit preferably emits the counter waves capable of defining the target space in a ceiling, a wall, a space between the walls, a crawl space or a dead space of the building, house or room. Of course, the counter unit may be configured to form the target space in other portions of the building, house, room or other structures or regions with least contact with the users or bystanders.

Accordingly, various principles and their application to various EMC systems and EMC methods of the present invention can be applied to above antennas or base units for “countering” the harmful waves inside the target space and decreasing their intensity by a preset extent or to maintain such an intensity below a preset limit. It is appreciated that such principles and their application may be applied to various EMC power transmission systems as will be described below.

A number of aspect and embodiments of the invention have been described. Nevertheless, it will be understood that various modifications may be made without departing from the spirit and scope of the invention.

In one example, the base unit may define various shapes such as, e.g., a curvilinear wire, a curvilinear coil or spiral, a ring, a curvilinear mesh, a curvilinear sheet or strip, a curvilinear cylinder, rod or tube, a sphere, a bead, a solenoid, a toroid, a truncation of any of the above, a fraction of any of the above, and a combination of any of the above. Then, one can use the solution of the Equations in such a way of determining at least one of the Second Characteristics and configuring the counter unit to define at least one of such shapes capable of emitting the counter waves for performing such “countering” to decrease the intensity of the harmful waves by the preset extent or to decrease such an intensity below the preset limit.

In another example, the base unit may be made of or include an electrically conductive material, an electrically semiconductive material, and/or an electrically insulative material. Then, one can use the solution of the Equations in such a way of determining at least one of the Second Characteristics and configuring the counter unit to be made of or include at least one of such materials so as to emit the counter waves capable of performing the “countering” to decrease the intensity of the harmful waves by the preset extent or to decrease such an intensity below the preset limit.

In another example, incorporated alongside the base unit or counter unit is at least one material of which magnetic permeability is different from that of the base unit, that of the counter unit or that of the target space. One can use the solution of the Equations to determine based thereon a composition of matter of the material, its shape, its size, and/or its disposition with respect to the counter unit, base unit, and/or target space in order to manipulate propagation path of the harmful and/or counter waves for the “countering” by the preset extent or below the preset limit. It is appreciated that these materials may include a conventional electric shielding material or a conventional magnetic shielding material.

In another example, the Second Characteristics may include a direction of the second electric current, a phase angle of the second current, and a direction of propagation of the counter waves. One can then use the solution of the Equations in such a way that at least one of the angle, direction of propagation, and current direction is determined depending on whether the counter waves perform the “countering” mainly by the “canceling” or the “suppressing.”

In another example, one can use the solution of the Equations to determine at least one of the Second Characteristics based thereon in such a way that a second vector representing a net flux of the counter waves may be configured to at least partially cancel a first vector representing a net flux of the harmful waves in the target space for the “countering” by the preset extent or below the preset limit. Alternatively, one can use the solution of the Equations to determine at least one of the Second Characteristics based thereon in such a way that the counter waves mainly cancel at least a portion of the harmful waves in the target space and, therefore, decrease the intensity of the harmful waves by the preset extent or below the preset limit. Above EMC systems or devices may include the sound generating device, the electric heating device, the electricity generating device, the device capable of generating electromotive force, the electric light emitting unit, and the like, where each of such devices has been defined hereinabove.

In another example, one can use the solution of the Equations to determine at least one of the Second Characteristics based thereon in such a way that a second vector representing a net flux of the counter waves may be configured to at least partially suppress, oppose or repel a first vector representing a net flux of the harmful waves in the target space by the preset extent or below the preset limit. Alternatively, one can use the solution of the Equations to determine at least one of the Second Characteristics based thereupon in such a way that the counter waves primarily suppress, oppose or repel at least a portion of the harmful waves from propagating into the target space and, therefore, decrease the intensity of the harmful waves by the preset extent or below the preset limit. Above EMC systems or devices may be the personal communication device, the areal communication device, the power transmission device, the sound generating device, the electric heating device, the device generating an electromotive force, the electricity generating device, the electric light emitting unit, and the like. The solution may be used to determine at least one of the Second Characteristics in such a way that the target space may enclose at least a portion of a preset region, and the wave source substantially may serve the purpose in almost all directions once outside the target space.

In another example, one can use the solution of the Equations to decrease the intensity of the harmful waves (or the sum of the first and second waves) in various target spaces which may be defined along, near, around, and/or under power grid systems and their power transmission lines. In addition, one can also manipulate the counter and base units of such power grid systems or devices in such a way that counter unit may define various target spaces along, near, around or under other parts of the system or device such as, e.g., a power plant, a common line, a transmission substation, a transmission tower, a power pole, and various transformers used therein. The above canceling or suppressing mechanisms may then be applied to such power grid systems in order to counter at least a portion of the harmful waves (or the sum of the first and second waves). One can use at least one of the transmission lines as the base unit, while using at least one of the rest as the counter unit. In the alternative, one can install at least one auxiliary transmission line and use this as the counter unit.

In another example, various base units of such EMC systems or devices irradiate the harmful waves define frequencies which are mainly less than about 1 kHz, from about 1 kHz to about 1 MHz, from about 1 MHz to about 1 GHz, higher than about 1 GHz, and the like. One can then use the solution of the Equations to determine at least one of the Second Characteristics based thereon in such a way that the counter waves define frequencies at least partially matching those of the harmful waves and performing the “countering” either by the “canceling” or “suppressing” by the preset extent or below the preset limit. In a related example, such counter waves may perform the “countering” over an entire frequency range of the harmful waves, in only a single portion of the range of the harmful waves, or at least two different portions of the range of the harmful waves.

In another example, the base and counter units are provided in a fixed arrangement. One can utilize the solution of the Equations in such a way that at least one of the Second Characteristics may change in response to at least one change in at least one of the First Characteristics. Accordingly, the counter unit can perform the “countering” by the preset extent or below the preset limit. In an opposite example, at least one of the base and counter units is provided in a mobile arrangement with respect to the base unit. One can then use the solution of the Equations to modify at least one of the Second Characteristics based thereon and to move at least a portion of the counter unit in order to perform the “countering” by the preset extent or below the preset limit.

In another example and as described above, one can use the Equations in various purposes such as, e.g., designing the counter unit based on the base unit and/or desired target space, forming the target space based on the base unit and/or counter unit, adjusting the base unit based upon the desired target space and/or desired counter unit, and the like. Accordingly, one can use the solution of at least one of the Equations to determine at least one Second Characteristics of the counter unit based upon a desired radiative pattern of the harmful waves, counter waves and/or a sum of both waves in the target space and/or based on at least one of the First Characteristics. In the alternative, one can use the solution at least one of the Equations to determine a radiative pattern of the harmful waves, counter waves, and/or a sum of such waves in the target space based on at least one of the First Characteristics or Second Characteristics. One can instead use the solution of at least one of the Equations to determine at least one of the First Characteristics of the counter unit based on a desired radiative pattern of the harmful waves, counter waves, and/or a sum of the waves inside the target space and/or based on at least one of the Second Characteristics.

In another example, one can use the solution of at least one of such Equations so as to design the counter unit which defines a configuration which at least partially match that of the base unit. In this embodiment, the wavefronts of the counter (or second) waves which are emitted by the counter unit would have a better chance of matching those of the base unit and, by properly operating the counter unit, would have a better chance of countering the harmful (or second) waves. This design mode is to be called the “shape matching” as disclosed in the co-pending U.S. application Ser. No. 11/510,667. In the alternative, one can use the solution of at least one of such Equations so as to render the counter (or second) waves at least partially match their wavefronts with those of the harmful (or first) waves. In this mode, the counter unit does not have to define the configuration which matches that of the base unit. This mode is to be called the “wave matching” as also has been described in the co-pending U.S. application Ser. No. 11/510,667.

In another example, the counter units of such EMC systems or devices of this invention may be provided for various purposes. As described in conjunction with the “canceling” mechanism above, the counter unit may emit the counter waves which preferentially cancel the harmful waves inside the target space, thereby decreasing the intensity of the harmful waves by the preset extent or below the preset limit. In this situation, the EMC system or devices may not properly function in the target space and, accordingly, the counter (or second) waves completely, at least substantially or at most partially impeding the purpose of the EMC system or device, while creating the target space to protect the user from the harmful waves. In contrary, as described regarding the “suppressing” mechanism above, the counter unit may emit the counter waves which preferentially suppress, oppose or repel the harmful waves from propagating into the target space, thereby decreasing the intensity of the harmful waves by the preset extent or below the preset limit. In this situation, the counter waves generally define the same or at least similar phase angle and/or direction of propagation. Accordingly, by disposing such a counter unit in a proper position, the EMC system or device may function properly outside and inside the target space and, accordingly, the counter (or second) waves completely, at least substantially or at most partially facilitating the purpose of the EMC system or device, while creating the target space to protect the user from the harmful waves. In a hybrid situation, the counter waves may be neutral to the purpose of the EMC system or device.

In all, one is generally given an option to choose whether to rely on the “canceling” mechanism or “suppressing mechanism” depending upon many factors such as, e.g., the First Characteristics of the base unit, Second Characteristics of the counter unit, purpose of the EMC system or device, and the like. For example, it may be preferable to select the “suppressing” mechanism for the “countering” for the EMC personal communication system, for it is important for such an EMC system to protect its user while ensuring that the user of the EMC personal communication system can communicate with others. The same applies to the areal communication system and power transmission system as well. However, one can always choose the “canceling” mechanism for such “countering” for the personal communication for better protection of the user while sacrificing capability of wireless communication inside the target space. As to the electricity heating device, the effective “countering” by “canceling” may end up terminating radiative heat transfer through infrared light rays which are irradiated from a heating element of the device. Therefore, it is preferable to employ the “suppressing” than “canceling” in such a heating device. Alternatively, the counter unit may be configured to emit the counter waves having frequencies not in the range of the infrared rays but in the range of carrier current such as 50 or 60 Hz. This configuration ensures effective radiative heat transfer while “countering” the harmful waves in the extremely low frequency range. As to the electricity generating device, “countering” by “suppressing” seems to be preferable to that by “canceling” by the similar reason, while “countering” by “canceling” can also be performed. Accordingly, selecting a proper mechanism of the “countering” and choosing the “countering” to serve the purpose of the EMC system or device or to impede such a purpose is generally within the capability of one of ordinary skill in the art.

Similarly, one is also given an option to choose what kind of target spaces is to be defined by various counter units of the present invention. In general, various spatial and wave-related features of the target space are determined based on the First Characteristics of the base unit and/or Second Characteristics of the counter unit, and/or the purpose of the EMC system or device. Thus and in one example, the features of the target space are mainly determined based on corresponding features of the active space which are defined by the harmful waves. In another example, the features of the target space are primarily determined by the interaction between the harmful and counter waves. In all, selecting a proper target space of a specific EMC device or system while minimally compromising or even facilitating the purpose of the very system or device is generally within the capability of one of ordinary skill in the art.

It is appreciated that the choice of the “canceling” or “suppressing” as the main mechanism of “countering” affects not only the intensity of the harmful waves (or the intensity of the sum of such first and second waves) in the target space as well as a degree of serving the purpose designated to the system or device. In one example where the main mechanism of “countering” is such “canceling,” the intensity of such waves in the target space is the lowest when the counter unit emits the counter (or second) waves. When the counter unit ceases to emit the counter (or second) waves, however, the intensity of the harmful waves (or the sum of the first and second waves) has to increase, for there is no countering inside the target space. In an opposite example where the main mechanism of “countering” is “suppressing,” the intensity of such waves in the target space is the lowest when the counter unit emits the counter waves (or second waves). When the counter unit ceases to emit such counter (or second) waves, however, the intensity of the harmful waves (or the sum of the first and second waves) similarly increases, for there is no countering in the target space. At the same time, however, the system or device serves its purpose in a less degree, because the counter (or second) waves in the “suppressing” mechanism may be designed to facilitate the harmful (or first) waves to serve the purpose. In this relative sense, as the counter unit ceases to emit the counter (or second) waves, the system or device increases such an intensity in the target space but serves the purpose in a less degree in the “canceling” mechanism, but the system or device decreases the intensity in the target space but facilitates the purpose in the “canceling” mechanism.

It is also appreciated that desirable target spaces for each of the sound generating device, the electric heating device, the electricity generating device, the device generating an electromotive force, the electric light emitting unit or device, the personal communication device, the areal communication device, and the power transmission device (and their EMC systems) have already been described in the above Summary. It is to be understood, however, that such target spaces for each of the above devices, units or systems can be expanded or shrunk depending upon many factors and, again, that selecting the proper target spaces of the above devices, units, and/or their EMC systems or devices generally fall within the capability of one of ordinary skill in the art.

In another example, at least one counter unit provided according to at least one aspect of the present invention may be constructed as a unit separate from the base unit and incorporated into the device to form an EMC system or device. For example, one or more counter units may be constructed based on the solution of at least one of the Equations, and incorporated into a personal communication device such as a cellular phone or a smart phone, thereby forming a target space in which an ear, a brain or other body parts of the user.

In another example, at least one base unit can be divided or separated into two or more smaller subunits, where such subunits may have the same or different shapes and/or sizes and where such subunits may be positioned in the same or different dispositions. In one case, at least one first subunit may function as the base unit, while at least one second subunit of the rest thereof may function as the counter unit. In this case, the first subunit may be viewed as the base unit, while the first waves irradiated therefrom may be viewed as the harmful waves. In another case, at least one first subunit may serve as a base unit, while at least one second subunit of the rest thereof may function as the counter unit or vice versa in such a way that the first waves from the first subunit may be viewed as the harmful waves, while the second waves from the second subunit may be viewed as the counter waves. Because each of both units serve as the base unit as well as the counter unit of another, it is appreciated that either of such units may be viewed as the first (or second) waves interacting with the second (or first) waves.

In another example, the counter unit may be designed according to configurations of the base unit and then disposed in such a way that the electromagnetic waves irradiated and emitted by each of the units may suppress each other from propagating into the target space, thereby decreasing the intensity of the harmful waves (or the sum of the first and second waves) by the preset amount or below the preset limit. Constructing the EMC system or device in this mode is particular useful when the base unit has a complicated configuration and/or when the harmful (or first) waves define very complicated wavefronts or radiative pattern, such that constructing the counter which has the similar configuration or designing the counter unit which is capable of emitting the counter waves of similar wavefronts may be time-consuming or very complicated. Example of such a base unit is an electric motor which includes at least a pair of permanent magnet and/or electromagnets. Therefore, examples of the EMC systems or devices including such base units include, a hair dryer, a vacuum cleaner and other devices. In addition, examples of EMC systems or devices including complicated base units may include a microwave oven, an induction heating device, and various electrical parts incorporated into transporting means such as, e.g., an electric automobile, a hybrid car, a train or street car including at least one motor or transformer, and the like. In these systems or devices, the base and counter units defining similar configurations or emitting the harmful and counter waves of similar wavefronts may be provided in various dispositions. For example, such units may be in a lateral disposition or side by side disposition. In another example, such units may be in a symmetric disposition. In another example, such units may be in a concentric disposition. In another example, such units may also be in different dispositions as have been described in the co-pending U.S. application Ser. No. 11/510,667.

When desirable, the above counter unit may be provided based on a Salisbury principle and/or a Salisbury screen. It is appreciated that the Salisbury-style counter unit may have to be constructed according to the frequency of the harmful waves irradiated by the base unit, because the countering capability of the counter waves emitted by the Salisbury-style counter unit depends on the frequency. Once the frequency of the counter waves proves to be suitable for the “countering,” such a counter unit may be incorporated according to various dispositions as described herein.

In another example, the device or EMC system or device of this invention may also include two or more counter units. These counter units may be shaped, sized, and disposed to enhance or ensure proper “countering” of the harmful waves. Thus, in one case, all counter units may be configured to perform the countering exclusively by the canceling or by the suppressing. Alternatively, at least one of such counter units may perform such “countering” by the canceling, at least one of the rest of the counter units may perform such “countering” by the suppressing, and the like. In another alternative, at least one first counter unit may perform the “countering” of the harmful waves as described above, while at least one second counter unit may rather irradiate the harmful waves in order to compensate potential “over-countering” of the harmful waves performed by the first counter unit inside the target space. When desirable, a third counter unit may be incorporated in order to fine-tune the “countering” and to define the target space with the most desirable shape, size, and disposition.

Unless otherwise specified, various features of one embodiment of one general aspect of the present invention apply interchangeably to other embodiments of the same or similar general aspect of this invention and/or embodiments of one or more of other aspects of this invention. Thus, one can use at least one solution of the at least one of the Equations to determine the Second Characteristics of the counter unit of any of the aforementioned electric or electronic devices based upon a desired radiative pattern of the harmful waves, counter waves or a sum of such in the target space and/or based on the First Characteristics. Alternatively, one can use at least one solution of at least one of the Equations to determine a radiative pattern of the harmful waves, counter waves or a sum of such in the target space based on the First and/or Second Characteristics. One can instead use at least one solution of at least one of the Equations to determine the First Characteristics of the counter unit based upon the desired radiative pattern of the harmful waves, counter waves or a sum of such in the target space and/or based on the Second Characteristics.

It is appreciated that, while various aspects and/or embodiments of this invention have been described in conjunction with the detailed description thereof, the foregoing description is intended to illustrate and not to limit the scope of this invention, which is defined by the scope of the appended claims. Further aspects, embodiments, advantages, and modifications are within the scope of the following claims.

What is claimed is:

1. A system which is provided for a preset purpose and configured to irradiate first and second electromagnetic waves and to define a target space comprising:
at least one wave source which is configured to function as a source of both of said first and second waves and to define at least one base unit as well as at least one counter unit therein,
wherein said base unit is configured to have first characteristics including its first composition of matter, its first configuration, its first path of first electric current defined therein, and first dynamic property of said first electric current flowing in said first path, and to irradiate said first waves,
wherein said counter unit is configured to define second characteristics including its second composition of matter, its second configuration, its second path of second electric current defined therein, second dynamic property of said second electric current flowing in said second path, and its disposition with respect to said base unit, and to emit said second waves, and
wherein at least one solution of at least one of a plurality of equations including Gauss law for magnetism, Gauss law, Faraday's law of induction, Ampere's circuital law, and Lorentz force law is obtained and utilized to determine at least one of said second characteristics in such a way that said second waves are capable of countering at least a portion of said first waves through at least one of canceling at least a portion of said first waves in said target space and suppressing at least a portion of said first waves from propagating into said target space, thereby decreasing an intensity of both of said first and second waves by a preset extent in said target space.

2. The system of claim 1, wherein said equations are expressed in at least one of a differential form in terms of free charge and current, a differential form in terms of total charge and current, an integral form in terms of free charge and current, and an integral form in terms of total charge and current and wherein said solution corresponds to at least one of an analytical solution of at least one of said equations, a numerical solution of at least one of said equations, an approximation of at least one of said solutions, and a combination of at least two of said solutions and approximations thereof.

3. The system of claim 1, wherein said first waves define frequencies which are mainly one of less than about 1 kHz, between about 1 kHz and about 1 MHz, between about 1 MHz and about 1 GHz, and higher than about 1 GHz and wherein said solution is used to determine at least one of said second characteristics in such a way that said second waves also have frequencies which at least partially match those of said first waves and perform said countering by said preset extent.

4. The system of claim 1, wherein said second waves perform said countering over one of an entire frequency range of said first waves, only a single portion of said range thereof, and a plurality of portions of said range thereof.

5. The system of claim 1, wherein said solution is used to determine at least one of said second characteristics in such a way that said counter unit performs said countering which is one of:
completely impeding said purpose;
at least substantially impeding said purpose;
at most partially impeding said purpose;
mainly neutral to said purpose;
at most partially facilitating said purpose;
at least substantially facilitating said purpose; and
completely facilitating said purpose.

6. The system of claim 1, wherein said solution is used to determine at least one of said second characteristics in such a way that said counter unit is disposed in one of a plurality of dispositions, a first of which is formed between said target space and base unit where said second waves define amplitudes less than those of said first waves, a second of which is formed on an opposite side of said target space relative to said base unit where said second waves define amplitudes enough to perform said countering by said extent, a third of which is positioned at a first distance from a center of said target space where said second waves define amplitudes enough to perform said countering by said extent, a fourth of which is defined at a third distance from said center in which said second waves have amplitudes enough to perform said countering by said extent, wherein said first distance is neither substantially greater nor substantially less than a second distance between said base unit and said center, and wherein said third distance is one of substantially greater and substantially less than said second distance.

7. The system of claim 1, wherein said solution is used to determine at least one of said second characteristics in such a way that said counter unit is configured to form said target space in at least one of a plurality of zones, a first of which is a two-dimensional zone defined in a preset relation to said counter unit, a second of which is a three-dimensional zone defined in another preset relation to said counter unit, a third of which is defined about at least a portion of said counter unit, a fourth of which is defined along at least a portion of said counter unit, a fifth of which is defined about at least one side of said counter unit, a sixth of which is defined lateral to at least a portion of said counter unit, a seventh of which is defined angularly about at least a portion of said counter unit, an eighth of which is defined one of on and over at least a portion of said counter unit, a ninth of which is defined in an elevation similar to at least a portion of said counter unit, and a tenth of which is defined one of below and under at least a portion of said counter unit.

8. The system of claim 1, wherein said solution is used to determine at least one of said second characteristics in such a way that said target space is configured to form one of an open space and a closed space, wherein said wave source is configured to serve said purpose only about a preset angle thereabout relative to said open target space, and wherein said wave source is configured to serve said purpose outside said closed target space.

9. The system of claim 1, wherein said base unit has at least one of a plurality of shapes which include a curvilinear wire, a curvilinear coil, a curvilinear spiral, a ring, a curvilinear mesh, a curvilinear sheet, a curvilinear strip, a curvilinear rod, a curvilinear cylinder, a curvilinear tube, a sphere, a bead, a solenoid, a toroid, a truncation thereof, a fraction thereof, and a combination thereof and wherein said solution is used to determine at least one of said second characteristics in such a way that said counter unit is configured to have at least one of said shapes and to emit said second waves which perform said countering by said extent.

10. The system of claim 1, wherein said base unit includes therein at least one of an electrically conductive material, an electrically semiconductive material, and an electrically insulative material and wherein said solution is used to determine at least one of said second characteristics in such a way that said counter unit is configured to include therein at least one of said materials and to emit said second waves which perform said countering by said extent.

11. The system of claim 1, wherein said second characteristics also include a direction of said second electric current, a phase angle of said second electric current, and a direction of propagation of said second waves and wherein said solution is used to determine at least two of said propagation direction, current direction, and angle depending on whether said second waves are performing said countering by either of said canceling and suppressing.

12. The system of claim 1, wherein said solution is used to determine at least one of said second characteristics in such a way that a second vector representing a net flux of said second waves is configured to at least partially cancel a first vector representing a net flux of said first waves in said target space.

13. The system of claim 1, wherein said solution is used to determine at least one of said second characteristics in such a way that said second waves primarily cancel at least a portion of said first waves in said target space and, accordingly, decrease said intensity of both of said first and second waves by said extent therein.

14. The system of claim 13, wherein said system is one of a sound generating device, an electric heating device, an electricity generating device, a device generating an electromotive force, and an electric light emitting unit.

15. The system of claim 1, wherein said solution is used to determine at least one of said second characteristics in such a way that a second vector representing a net flux of said second waves is configured to at least partially oppose a first vector representing a net flux of said first waves in said target space.

16. The system of claim 1, wherein said solution is used to determine at least one of said second characteristics in such a way that said second waves mainly suppress at least a portion of said first waves from propagating into said target space and, therefore, decrease said intensity of both of said first and second waves by said extent therein.

17. The system of claim 16, wherein said system is one of a personal communication device, an areal communication device, and a power transmission device.

18. The system of claim 17, wherein said solution is used to determine at least one of said second characteristics in such a way that said target space encloses at least a portion of a preset region, while said wave source is substantially capable of serving said purpose outside said target space.

19. The system of claim 16, wherein said system is one of a sound generating device, an electric heating device, an electricity generating device, a device generating an electromotive force, and an electric light emitting unit.

20. The system of claim 1, wherein said counter unit is configured to be provided in a plurality of dispositions, in a first of which said base unit and counter unit are provided in different regions of said wave source, in a second of which said base unit and counter unit are provided in one region of said wave source but one over the other, in a third of which at least a portion of one of said base unit and counter unit encloses at least a portion of the other of said units, in a fourth of which at least portions of said base and counter units intertwine each other, in a fifth of which at least portions of said base and counter units are disposed side by side, and in a sixth of which at least a portion of one of said base and counter units wind about at least a portion of the other of said units.

21. The system of claim 1, wherein said solution is used in changing at least one of said second characteristics in response to at least one change in at least one of said first characteristics of said base unit, thereby performing said countering by said extent despite said change.

22. The system of claim 1, wherein at least a portion of said counter unit is configured to be in one of a stationary arrangement and mobile arrangement with respect to said base unit and wherein said solution is used to one of modify at least one of said second characteristics and move at least a portion of said counter unit in such a way to ensure said second waves to perform said countering by said extent.

23. The system of claim 1, wherein said counter unit incorporates therein at least one material of which magnetic permeability is different from at least one of those of said base unit and target space and wherein said solution is used to determine at least one of a composition of matter of said material, a shape thereof, a size thereof, and a disposition thereof with respect to at least one of said counter unit, base unit, and target space so as to manipulate propagation path of at least one of said first and second waves for said countering.

24. A portable communication system which is used for wireless communication and configured to irradiate first and second electromagnetic waves and to define a target space comprising:
at least one wave source which is configured to function as a source of both of said first and second waves and to define at least one base unit as well as at least one counter unit therein,
wherein said base unit includes at least one transmitting module and is configured to irradiate said first waves which are configured to carry therealong information for said communication,
wherein said counter unit is configured to define second characteristics including its second composition of matter, its second configuration, its second path of second electric current defined therein, second dynamic property of said second electric current flowing in said second path, and its disposition with respect to said base unit, and to emit said second waves, and
wherein at least one solution of at least one of a plurality of equations including Gauss law for magnetism, Gauss law, Faraday's law of induction, Ampere's circuital law, and Lorentz force law is obtained and utilized to determine at least one of said second characteristics in such a way that said second waves are capable of countering at least a portion of said first waves through at least one of canceling at least a portion of said first waves in said target space and suppressing at least a portion of said first waves from propagating into said target space,
whereby said second waves form said target space which encloses therein at least one of a geographic area, at least one country, at least one city, at least one district, at least one city block, at least one building, and at least one house, and in which an intensity of both of said first and second waves is decreased by a preset extent.

25. The system of claim 24 further comprising a front side and a back side, wherein said front side is positioned toward an ear of said user during said communication and wherein said solution is used to determine at least one of said second characteristics of said counter unit in such a way that said second waves form said target space which spans from at least a portion of said front side and then widens in a forward direction toward said user, thereby enclosing therein at least one of said portion of said body, said half of said body, said head, and said brain.

26. The system of claim 25, wherein said target space has a shape of one of an enclosed conduit which extends from said front side toward said user through said active space and an open channel which traverses from said front side through said active space while dividing said active space into at least two separate smaller active spaces.

27. The system of claim 25, wherein said solution is used to determine at least one of said second characteristics of said counter unit in such a way that said second waves form said target space not in an opposite direction of said forward direction in order to minimize impeding said communication by said first waves.

28. An areal communication system which is used for wireless communication and configured to irradiate first and second electromagnetic waves and to define a target space comprising:
at least one wave source which is configured to function as a source of both of said first and second waves and to define at least one base unit as well as at least one counter unit therein,
wherein said base unit includes at least one transmitting module which is incorporated on one of a tower, a pole, and a mast, and is configured to irradiate said first waves which carry therealong information for said communication,
wherein said counter unit is configured to define second characteristics including its second composition of matter, its second configuration, its second path of second electric current defined therein, second dynamic property of said second electric current flowing in said second path, and its disposition with respect to said base unit, and to emit said second waves, and
wherein at least one solution of at least one of a plurality of equations including Gauss law for magnetism, Gauss law, Faraday's law of induction, Ampere's circuital law, and Lorentz force law is obtained and utilized to determine at least one of said second characteristics in such a way that said second waves are capable of countering at least a portion of said first waves through at least one of canceling at least a portion of said first waves in said target space and suppressing at least a portion of said first waves from propagating into said target space,
whereby said second waves form said target space which encloses therein at least one of a geographic area, at least one country, at least one city, at least one district, at least one city block, at least one building, and at least one house and in which an intensity of both of said first and second waves is decreased by a preset extent.

29. The system of claim 28, wherein each of said tower, pole, and mast has a top and a bottom, wherein said counter unit is disposed at least one of below and inside of said base unit, and wherein said solution is used to determine at least one of said second characteristics of said counter unit in such a way that said second waves form said target space which defines a shape of at least one of a sphere, a cone, a ring, a portion thereof, a truncation thereof, and a combination thereof, thereby enclosing therein at least one of said area, country, city, district, block, building, and house.

30. The system of claim 29 also comprising a third unit which emits third electromagnetic waves, wherein said third unit is positioned at least one of below and inside said counter unit, and wherein said third waves are configured to counter said second waves by at least one of canceling at least a portion of said second waves in said target space and suppressing at least a portion of said second waves from propagating through said target space, thereby forming said target space defining said intensity which is relatively uniform throughout said target space than said intensity obtained without said third unit.

31. A power transmission system which is used for wireless power transmission and configured to irradiate first and second electromagnetic waves and to define a target space comprising:
at least one wave source which is configured to function as a source of both of said first and second waves and to define at least one base unit as well as at least one counter unit therein,
wherein said base unit includes therein at least one transmitting module which is configured to irradiate said first waves which carry therealong electromagnetic power for said power transmission,
wherein said counter unit is configured to define second characteristics including its second composition of matter, its second configuration, its second path of second electric current defined therein, second dynamic property of said second electric current flowing in said second path, and its disposition with respect to said base unit, and to emit said second waves, and
wherein at least one solution of at least one of a plurality of equations including Gauss law for magnetism, Gauss law, Faraday's law of induction, Ampere's circuital law, and Lorentz force law is obtained and utilized to determine at least one of said second characteristics in such a way that said second waves are capable of countering at least a portion of said first waves through at least one of canceling at least a portion of said first waves in said target space and suppressing at least a portion of said first waves from propagating into said target space,
whereby said second waves form said target space which encloses therein at least one of at least one building, at least one house, and at least one room and in which an intensity of both of said first and second waves is decreased by a preset extent.

32. The system of claim 31, wherein said solution is used to determine at least one of said second characteristics of said counter unit in such a way that said second waves form said target space in a plurality of portions of said building, house, and room which warrant frequent contact with persons, and wherein said second waves perform said countering at most minimally in the rest of said building, house, and room which warrants the least contact with persons to allow said power transmission.

33. The system of claim 32, wherein said solution is used to determine at least one of said second characteristics of said counter unit in such a way that said second waves perform said countering at most minimally in at least one of a ceiling, a wall, a space between said walls, a crawl space, and a dead space of said building, house, and room.

34. A system including at least one wave source with at least one base unit which is configured to incorporate only portions of said wave source which are responsible for at least one of irradiating harmful electromagnetic waves and affecting paths of propagation of said harmful waves therealong, wherein said base unit has first characteristics which include its first composition of matter, its first configuration, its first path of first electric current defined therein, and first dynamic property of said first electric current flowing in said first path, and wherein said wave source irradiates said harmful waves to accomplish a preset purpose of said system, said system comprising:
at least one counter unit which is configured to define second characteristics which include its second composition of matter, its second configuration, its second path of second electric current defined therein, second dynamic property of said second electric current flowing in said second path, and its disposition with respect to said base unit, and to emit counter electromagnetic waves which are capable of countering at least a portion of said harmful waves through at least one of canceling at least a portion of said harmful waves inside a target space and suppressing at least a portion of said harmful waves from propagating to said target space, thereby decreasing an intensity of said harmful waves in said target space by a preset extent,
wherein at least one of said second characteristics of said counter unit is determined based on at least one solution of at least one of a plurality of equations including Gauss law, Gauss law for magnetism, Faraday's law of induction, Ampere's circuital law, and Lorentz force law in such a way that said counter waves are capable of performing said countering by said preset extent in said target space.

35. The system of claim 34, wherein said equations are expressed in at least one of a differential form in terms of free charge and current, a differential form in terms of total charge and current, an integral form in terms of free charge and current, and an integral form in terms of total charge and current and wherein said solution corresponds to at least one of an analytical solution of at least one of said equations, a numerical solution of at least one of said equations, an approximation of at least one of said solutions, and a combination of said solutions and approximations thereof.

36. The system of claim 34, wherein said harmful waves define frequencies which are mainly one of less than about 1 kHz, between about 1 kHz and about 1 MHz, between about 1 MHz and about 1 GHz, and higher than about 1 GHz and wherein said solution is used to determine at least one of said second characteristics in such a way that said counter waves also have frequencies which at least partially match those of said harmful waves and perform said countering by said preset extent.

37. A portable communication system having at least one wave source including at least one base unit which includes at least one transmitting module which irradiates harmful electromagnetic waves carrying therealong information for a purpose of wireless communication, wherein said base unit has first characteristics including its first composition of matter, its first configuration, its first path of first electric current defined therein, and first dynamic property of said first electric current flowing in said first path comprising:
at least one counter unit which is configured to define second characteristics which include its second composition of matter, its second configuration, its second path of second electric current defined therein, second dynamic property of said second electric current flowing in said second path, and its disposition with respect to said base unit, and to emit counter electromagnetic waves which are capable of countering at least a portion of said harmful waves through at least one of canceling at least a portion of said harmful waves inside a target space and suppressing at least a portion of said harmful waves from propagating to said target space, thereby decreasing an intensity of said harmful waves in said target space by a preset extent,
wherein at least one of said second characteristics of said counter unit is determined based on at least one solution of at least one of a plurality of equations including Gauss law, Gauss law for magnetism, Faraday's law of induction, Ampere's circuital law, and Lorentz force law in such a way that said counter waves form said target space which encloses one of a substantial portion of a body of a user of said system, about a half of said body of said user, a head thereof, and a brain thereof and in which said countering decreases said intensity of said harmful waves by said preset extent.

38. An areal communication system having at least one wave source including at least one base unit which includes at least one transmitting module which irradiates harmful electromagnetic waves carrying therealong information for a purpose of wireless communication, wherein said base unit has first characteristics including its first composition of matter, its first configuration, its first path of first electric current defined therein, and first dynamic property of said first electric current flowing in said first path and where said base unit is incorporated on one of a tower, a pole, and a mast comprising:
at least one counter unit which is configured to define second characteristics which include its second composition of matter, its second configuration, its second path of second electric current defined therein, second dynamic property of said second electric current flowing in said second path, and its disposition with respect to said base unit, and to emit counter electromagnetic waves which are capable of countering at least a portion of said harmful waves through at least one of canceling at least a portion of said harmful waves inside a target space and suppressing at least a portion of said harmful waves from propagating to said target space, thereby decreasing an intensity of said harmful waves in said target space by a preset extent,
wherein at least one of said second characteristics of said counter unit is determined based on at least one solution of at least one of a plurality of equations including Gauss law, Gauss law for magnetism, Faraday's law of induction, Ampere's circuital law, and Lorentz force law in such a way that said counter waves form said target space which encloses one of a geographic area, at least one country, at least one city, at least one district, at least one city block, at least one building, and at least one house and in which said countering decreases said intensity of said harmful waves by said preset extent.

39. A power transmission system having at least one wave source having at least one base unit which includes at least one transmitting module which irradiates harmful electromagnetic waves that carry therealong electromagnetic power for a purpose of wireless power transmission, wherein said base unit has first characteristics including its first composition of matter, its first configuration, its first path of first electric current defined therein, and first dynamic property of said first electric current flowing in said first path comprising:
at least one counter unit which is configured to define second characteristics which include its second composition of matter, its second configuration, its second path of second electric current defined therein, second dynamic property of said second electric current flowing in said second path, and its disposition with respect to said base unit, and to emit counter electromagnetic waves which are capable of countering at least a portion of said harmful waves through at least one of canceling at least a portion of said harmful waves inside a target space and suppressing at least a portion of said harmful waves from propagating to said target space, thereby decreasing an intensity of said harmful waves in said target space by a preset extent,
wherein at least one of said second characteristics of said counter unit is determined based on at least one solution of at least one of a plurality of equations including Gauss law, Gauss law for magnetism, Faraday's law of induction, Ampere's circuital law, and Lorentz force law in such a way that said counter waves form said target space which encloses therein one of at least one building, at least one house, and at least one room and in which said countering decreases said intensity of said harmful waves by said preset extent.

40. A system which includes at least one base unit defining first characteristics including its first composition of matter, its first configuration, its first path of first electric current defined therein, and first dynamic property of said first electric current flowing in said first path, wherein said base unit serves a preset purpose of said system by irradiating harmful electromagnetic waves propagating around at least a portion of said base unit and defining an active space in which an intensity of said harmful waves exceeds a preset limit, and wherein said system forms in said active space at least one target space in which said intensity of said harmful waves is configured to be decreased below said limit, said system comprising:
at least one counter unit which is configured to define second characteristics which includes its second composition of matter, its second configuration, its second path of second electric current defined therein, second dynamic property of said second electric current flowing in said second path, and its disposition with respect to said base unit, and to emit counter electromagnetic waves,
wherein at least one of said second characteristics of said counter unit is determined based on at least one solution of at least one of a plurality of equations including Gauss law, Gauss law for magnetism, Faraday's law of induction, Ampere's circuital law, and Lorentz force law in such a way that said counter waves are capable of countering at least a portion of said harmful waves through at least one of canceling at least a portion of said harmful waves in said target space and suppressing at least a portion of said harmful waves from propagating into said target space, thereby defining in said active space said target space which has a preset shape with a preset cross-section, a preset size, and a preset disposition and in which said intensity of said harmful waves is maintained below said limit.

41. The system of claim 40, wherein said solution is used to determine at least one of said second characteristics in such a way that said counter waves perform said countering which is one of:
completely impeding said harmful waves from serving said purpose;
at least substantially impeding said harmful waves from serving said purpose;
at most partially impeding said harmful waves from serving said purpose;
mainly neutral to said harmful waves in serving said purpose;
at most partially facilitating said harmful waves in serving said purpose;
at least substantially facilitating said harmful waves in serving said purpose; and
completely facilitating said harmful waves in serving said purpose.

42. The system of claim 40, wherein said solution is used to determine at least one of said second characteristics of said counter unit in such a way that said intensity of said harmful waves inside said target space is less than said limit but greater than a minimum threshold to serve said purpose so that said base unit is configured to at least minimally serve said purpose in at least a substantial portion of said target space while said counter unit is performing said countering therein.

43. The system of claim 40, wherein said solution is used to determine at least one of said second characteristics of said counter unit in such a way that said intensity of said harmful waves inside said target space is less than said limit but defines one of a plurality of distributions, wherein said intensity is greatest near a boundary of said target space in a first of said distributions, wherein said intensity is at least partly uniform in a substantial portion of said target space in a second of said distributions, wherein said intensity is lowest near said counter unit in a third of said distributions, and wherein said intensity is lowest between at least two of said counter units in a fourth of said distributions.

44. A portable communication system including at least one base unit defining first characteristics that includes its first composition of matter, its first configuration, its first path of first electric current defined therein, and first dynamic property of said first current flowing in said first path and including at least one transmitting module which irradiates harmful electromagnetic waves propagating around at least a portion of said transmitting module and defining an active space in which an intensity of said harmful waves exceeds a preset limit, wherein said transmitting module serves a purpose of wireless communication by irradiating said harmful waves which carry therealong communication information and wherein said system forms in said active space at least one target space in which said intensity of said harmful waves is configured to be decreased below said limit, said system comprising:
at least one counter unit which is configured to define second characteristics which includes its second composition of matter, its second configuration, its second path of second electric current defined therein, second dynamic property of said second electric current flowing in said second path, and its disposition with respect to said base unit, and to emit counter electromagnetic waves,
wherein at least one of said second characteristics of said counter unit is determined based on at least one solution of at least one of a plurality of equations including Gauss law, Gauss law for magnetism, Faraday's law of induction, Ampere's circuital law, and Lorentz force law in such a way that said counter waves are capable of countering at least a portion of said harmful waves through at least one of canceling at least a portion of said harmful waves in said target space and suppressing at least a portion of said harmful waves from propagating into said target space, thereby defining in said active space said target space which encloses at least one of a substantial portion of a body of a user of said system, about a half of said body of said user, a head thereof, and a brain thereof and in which said countering decreases said intensity of said harmful waves below said limit.

45. An areal communication system including at least one base unit defining first characteristics that includes its first composition of matter, its first configuration, its first path of first electric current defined therein, and first dynamic property of said first current flowing in said first path and including at least one transmitting module which irradiates harmful electromagnetic waves propagating around at least a portion of said transmitting module and defining an active space in which an intensity of said harmful waves exceeds a preset limit, wherein said transmitting module serves a purpose of wireless communication by irradiating said harmful waves which carry therealong communication information, wherein said base unit is disposed on one of a tower, a pole, and a mast, and wherein said system forms in said active space at least one target space in which said intensity of said harmful waves is configured to be decreased below said limit, said system comprising:
at least one counter unit which is configured to define second characteristics which includes its second composition of matter, its second configuration, its second path of second electric current defined therein, second dynamic property of said second electric current flowing in said second path, and its disposition with respect to said base unit, and to emit counter electromagnetic waves,
wherein at least one of said second characteristics of said counter unit is determined based on at least one solution of at least one of a plurality of equations including Gauss law, Gauss law for magnetism, Faraday's law of induction, Ampere's circuital law, and Lorentz force law in such a way that said counter waves are capable of countering at least a portion of said harmful waves through at least one of canceling at least a portion of said harmful waves in said target space and suppressing at least a portion of said harmful waves from propagating into said target space, thereby defining in said active space said target space which encloses therein at least one of a geographic area, at least one country, at least one city, at least one district, at least one city block, at least one building, and at least one house and in which said countering decreases said intensity of said harmful waves below said limit.

46. A power transmission system incorporating at least one base unit defining first characteristics including its first composition of matter, its first configuration, its first path of first electric current defined therein, and first dynamic property of said first current flowing in said first path and including at least one transmitting module which irradiates harmful electromagnetic waves propagating around at least a portion of said transmitting module and defining an active space in which an intensity of said harmful waves exceeds a preset limit, wherein said transmitting module serves a purpose of wireless power transmission by irradiating said harmful waves which carry therealong electromagnetic power and wherein said system forms in said active space at least one target space in which said intensity of said harmful waves is configured to be decreased below said limit, said system comprising:
at least one counter unit which is configured to define second characteristics which includes its second composition of matter, its second configuration, its second path of second electric current defined therein, second dynamic property of said second electric current flowing in said second path, and its disposition with respect to said base unit, and to emit counter electromagnetic waves,
wherein at least one of said second characteristics of said counter unit is determined based on at least one solution of at least one of a plurality of equations including Gauss law, Gauss law for magnetism, Faraday's law of induction, Ampere's circuital law, and Lorentz force law in such a way that said counter waves are capable of countering at least a portion of said harmful waves through at least one of canceling at least a portion of said harmful waves in said target space and suppressing at least a portion of said harmful waves from propagating into said target space, thereby defining in said active space said target space which encloses at least one of at least one building, at least one house, and at least one room and in which said countering decreases said intensity of said harmful waves below said limit.

47. A system which is provided for a preset purpose and configured to irradiate first and second electromagnetic waves and to define a target space comprising:
at least one wave source which is configured to function as a source of both of said first and second waves and to define at least one base unit as well as at least one counter unit therein,
wherein said base unit is configured to have first characteristics including its first composition of matter, its first configuration, its first path of first electric current defined therein, and first dynamic property of said first electric current flowing in said first path, and to irradiate said first waves which propagate about at least a portion of said base unit and define an active space thereabout in which an intensity of said first waves exceeds a preset limit,
wherein said counter unit is configured to define second characteristics including its second composition of matter, its second configuration, its second path of second electric current defined therein, second dynamic property of said second electric current flowing in said second path, and its disposition with respect to said base unit, and to emit said second waves, and
wherein at least one solution of at least one of a plurality of equations including Gauss law for magnetism, Gauss law, Faraday's law of induction, Ampere's circuital law, and Lorentz force law is obtained and utilized to determine at least one of said second characteristics in such a way that said second waves are capable of countering at least a portion of said first waves through at least one of canceling at least a portion of said first waves in said target space and suppressing at least a portion of said first waves from propagating into said target space,
whereby said second waves define inside said active space said target space which defines a preset shape with a preset cross-section, a preset size, and a preset disposition and in which said intensity of both of said first and second waves is maintained below said limit.

48. The system of claim 47, wherein said solution is used to determine at least one of said second characteristics in such a way that said second waves perform said countering which is one of:
completely impeding said first waves from serving said purpose;
at least substantially impeding said first waves from serving said purpose;
at most partially impeding said first waves from serving said purpose;
mainly neutral to said first waves in serving said purpose;
at most partially facilitating said first waves in serving said purpose;
at least substantially facilitating said first waves in serving said purpose; and
completely facilitating said first waves in serving said purpose.

49. The system of claim 47, wherein said solution is used to determine at least one of said second characteristics of said counter unit in such a way that said intensity of said first waves in said target space is below said limit but greater than a minimum threshold to serve said purpose so that said base unit is configured to at least minimally serve said purpose in at least a substantial portion of said target space while said counter unit is performing said countering therein.

50. The system of claim 47, wherein said solution is used to determine at least one of said second characteristics of said counter unit in such a way that said intensity of said first waves in said target space is below said limit but has one of a plurality of distributions, wherein said intensity is greatest near a boundary of said target space in a first of said distributions, wherein said intensity is at least partly uniform in a substantial portion of said target space in a second of said distributions, wherein said intensity is lowest near said counter unit in a third of said distributions, and wherein said intensity is lowest between at least two of said counter units in a fourth of said distributions.

51. The system of claim 47, wherein said solution is used to determine at least one of said second characteristics of said counter unit in such a way that said target space forms a cross-section which defines at least one of a plurality of two-dimensional shapes including a triangle, a square, a diamond, a rectangle, a trapezoid, a polygon having at least five sides, a polygon with at least one curved side, a circle, an annulus, a crescent, an ellipse, an oval, a shape with at least one parabolic side, a shape including at least one hyperbolic side, a shape with an arcuate side, a lemniscate, an astroid, a lune, a deltoid, a fraction of one of said shapes, a truncation of one of said shapes, one of said shapes with at least one rounded corner, and a combination thereof.

52. The system of claim 51, wherein said solution is used to determine at least one of said second characteristics of said counter unit in such a way that said target space forms a volume which has at least one of a plurality of three-dimensional shapes including a sphere, a hemisphere, a cone, a cube, a polyhedron, an ellipsoid, a three-dimensional volume obtained by at least one of translating, rotating, and revolving at least one of said two-dimensional shapes, a truncation thereof, a fraction thereof, and a combination thereof.

53. The system of claim 47, wherein said solution is used to determine at least one of said second characteristics of said counter unit in such a way that said target space is provided in at least one of a plurality of dispositions in first of which said target space is entirely enclosed by said active space, in a second of which said target space is partially enclosed by said active space and open through a single portion a boundary of said active space to an exterior of said active space, in a third of which said target space traverses through said target space while defining a conduit therethrough, and in a fourth of which said target space traverses through said space while dividing said active space into at least two separate smaller spaces.

54. The system of claim 47, wherein said counter unit is also provided in one of a contiguous and separate configuration, wherein at least a portion of said counter unit is incorporated into said wave source in said contiguous configuration so that said base and counter units are configured to be at least one of physically and electrically contiguous, and wherein at least a portion of said counter unit is disposed separately from said wave source in said separate configuration so that said counter unit is configured to be at least one of physically and electrically separate from said base unit.

55. The system of claim 47, wherein said base unit includes therein at least one of an electrically conductive material, an electrically semiconductive material, and an electrically insulative material and wherein said solution is used to determine at least one of said second characteristics in such a way that said counter unit is configured to incorporate at least one of said materials and to form said target space which has at least one of said shape, cross-section, size, and disposition and in which said intensity of both of said first and second waves is maintained below said limit.

56. The system of claim 47, wherein said solution is used to determine at least one of said second characteristics of said counter unit in such a way that said target space has at least one of a plurality of sizes including a first size which is as large as said active space, a second size which is smaller than said active space, a third size which corresponds to a size of at least one corner of said active space, a fourth size which corresponds to a size of at least one strip which extends across at least a portion of said active space, a fifth size which is large enough to enclose a preset local geographic area therein, a sixth size which is large enough to enclose therein at least two people, a seventh size which is smaller than said sixth size but large enough to enclose therein a single user of said system, an eighth size which is large enough to enclose therein a substantial portion of a body of said user, a ninth size which is large enough to enclose therein about one half of said body of said user, a tenth size which is large enough to enclose therein a head of said user, and an eleventh size which is large enough to enclose a brain of said user.

57. The system of claim 56, wherein said second characteristics further include a direction of said second electric current, a phase angle of said second electric current, and a propagation direction of said second waves and wherein said solution is used to determine at least two of said second angle, current direction, and propagation direction in such a way to determine whether said second waves perform said countering mainly by either of said canceling and suppressing.

58. The system of claim 56, wherein said solution is used to determine at least one of said second characteristics in such a way that said second waves mainly cancel at least a portion of said first waves in said target space and, accordingly, define said target space which has one of said sizes in which said intensity of both of said first and second waves is maintained below said limit.

59. The system of claim 58, wherein said system is one of a sound generating device, an electric heating device, an electricity generating device, a device generating an electromotive force, and an electric light emitting unit and wherein said solution is used to determine at least one of said second characteristics in order to define said target space which has one of said first, second, third, fourth, sixth, seventh, eighth, ninth, tenth, and eleventh sizes.

60. The system of claim 56, wherein said solution is used to determine at least one of said second characteristics in such a way that said second waves primarily suppress at least a portion of said first waves from propagating into said target space and, accordingly, define said target space which defines one of said sizes in which said intensity of both of said first and second waves is maintained below said limit.

61. The system of claim 60, wherein said system is one of a personal communication device, an areal communication device, and a power transmission device, wherein said solution is used in order to determine at least one of said second characteristics and to form said target space which has one of said second, third, fourth, sixth, seventh, eighth, ninth, tenth, and eleventh sizes for said personal communication device, wherein said solution is instead used to determine at least one of said second characteristics and to form said target space which defines one of said first, second, third, fourth, fifth, and sixth sizes for said areal communication device, and wherein said solution is instead used to determine at least one of said second characteristics and to form said target space having one of said first, second, third, fourth, fifth, sixth, seventh, eighth, and ninth sizes for said power transmission device.

62. The system of claim 60, wherein said system is one of a sound generating device, an electric heating device, an electricity generating device, a device generating an electromotive force, and an electric light emitting unit and wherein said solution is used to determine at least one of said second characteristics and to form said target space which has one of said first, second, third, fourth, sixth, seventh, eighth, ninth, tenth, and eleventh sizes.

63. The system of claim 47, wherein said counter unit is configured to be provided in a plurality of dispositions, in a first of which said base unit and counter unit are provided in different regions of said wave source, in a second of which said base unit and counter unit are provided in one region of said wave source but one over the other, in a third of which at least a portion of one of said base unit and counter unit encloses at least a portion of the other of said units, in a fourth of which at least portions of said base and counter units intertwine each other, in a fifth of which at least portions of said base and counter units are disposed side by side, and in a sixth of which at least a portion of one of said base and counter units wind about at least a portion of the other of said units.

64. The system of claim 47, wherein said solution is used in changing at least one of said second characteristics in response to at least one change in at least one of said first characteristics of said base unit, thereby defining said target space which have at least two of said shape, cross-section, size, and disposition and in which said intensity of both of said first and second waves is maintained below said limit.

65. The system of claim 47, wherein at least a portion of said counter unit is configured to be in one of a stationary arrangement and mobile arrangement with respect to said base unit and wherein said solution is used to one of modify at least one of said second characteristics and move at least a portion of said counter unit in such a way to ensure said second waves to define said target space which also defines at least two of said shape, cross-section, size, and disposition and in which said intensity of both of said first and second waves is maintained below said limit.

66. The system of claim 47, wherein said counter unit incorporates therein at least one material of which magnetic permeability is different from at least one of those of said base unit and target space and wherein said solution is used to determine at least one of a composition of matter of said material, a shape thereof, a size thereof, and a disposition thereof with respect to at least one of said counter unit, base unit, and target space so as to manipulate propagation path of at least one of said first and second waves for said countering.

67. The system of claim 47, wherein said target space is a territory of Korea which includes the Aprok River and Duman River as a northern border, Dokdo in the East Sea as the eastern border, and Ieodo in the South Sea as the southern border.
